(19) United States
(12) Patent Application Publication
(10) Pub. No.: US 2024/0205315 A1
(43) Pub. Date: Jun. 20, 2024

(54) HANDHELD ELECTRONIC DEVICE

(71) Applicant: Apple Inc., Cupertino, CA (US)

(72) Inventors: Benjamin J. Pope, Woodside, CA (US); Wing Shan Wong, Woodside, CA (US)

(21) Appl. No.: 18/085,442

(22) Filed: Dec. 20, 2022

(51) Int. Cl. H04M 1/02

(52) U.S. Cl. CPC H04M 1/0249; H04M 1/0262; H04M 1/0264; H04M 1/0274

(57) ABSTRACT

A mobile phone may include a housing structure defining a peripheral wall and a front cover formed of glass and coupled to the housing structure and defining at least a portion of a front exterior surface of the mobile phone. The mobile phone may further include a display below the front cover, a circuit board assembly coupled to the housing structure, and a removable rear cover assembly coupled to the housing structure and including a rear cover formed of glass, a rear-facing camera window, a charging coil coupled to the rear cover and configured to wirelessly receive power for charging the mobile phone, and an electrical connector conductively coupling the rear cover assembly to the circuit board assembly. The mobile phone may further include a supplemental housing component configured to be coupled to the housing structure in place of the removable rear cover assembly.

### FIELD

The subject matter of this disclosure relates generally to handheld electronic devices, and more particularly, to mobile phones.

### BACKGROUND

Modern consumer electronic devices take many shapes and forms, and have numerous uses and functions. Smartphones, for example, provide various ways for users to interact with other people that extend beyond telephone communications. Such devices may include numerous systems to facilitate such interactions. For example, a smartphone may include a touch-sensitive display for providing graphical outputs and for accepting touch inputs, wireless communications systems for connecting with other devices to send and receive voice and data content, cameras for capturing photographs and videos, and so forth. However, integrating these subsystems into a compact and reliable product that is able to withstand daily use presents a variety of technical challenges. The systems and techniques described herein may address many of these challenges while providing a device that offers a wide range of functionality.

### SUMMARY

A mobile phone may include a housing structure defining a peripheral wall and a front cover formed of glass and coupled to the housing structure and defining at least a portion of a front exterior surface of the mobile phone. The mobile phone may further include a display below the front cover, a circuit board assembly coupled to the housing structure, and a removable rear cover assembly coupled to the housing structure and including a rear cover formed of glass, a rear-facing camera window, a charging coil coupled to the rear cover and configured to wirelessly receive power for charging the mobile phone, and an electrical connector conductively coupling the rear cover assembly to the circuit board assembly. The mobile phone may further include a supplemental housing component configured to be coupled to the housing structure in place of the removable rear cover assembly and including a rear wall formed of a material other than glass and configured to define a rear exterior surface of the mobile phone when the supplemental housing component is coupled to the housing structure in place of the removable rear cover assembly, and a side wall extending from the rear wall and configured to cover at least a portion of the peripheral wall and define a side exterior surface of the mobile phone when the supplemental housing component is coupled to the housing structure in place of the removable rear cover assembly.

The housing structure may include a first metal segment defining a first portion of the peripheral wall, a second metal segment defining a second portion of the peripheral wall, and a nonconductive joint structure retaining the first metal segment and the second metal segment and defining a third portion of the peripheral wall. The first metal segment may be a first antenna of the mobile phone, the second metal segment may be a second antenna of the mobile phone, and the side wall of the supplemental housing component covers the first metal segment, the second metal segment, and the nonconductive joint structure.

The removable rear cover assembly may further include a microphone and a flash, and the electrical connector may conductively couple the charging coil, the microphone, and the flash to the circuit board assembly. The supplemental housing component may include a supplemental charging coil coupled to the rear wall and configured to wirelessly receive power for charging the mobile phone, a supplemental microphone, a supplemental flash, and a supplemental electrical connector configured to conductively couple the supplemental charging coil, the supplemental microphone, and the supplemental flash to the circuit board assembly when the supplemental housing component is coupled to the housing structure in place of the removable rear cover assembly.

The mobile phone may further include a battery, the supplemental housing component may further include a supplemental battery, and the supplemental electrical connector may be configured to conductively couple the supplemental battery to the circuit board assembly when the supplemental housing component is coupled to the housing structure in place of the removable rear cover assembly.

The peripheral wall may define four side exterior surfaces of the housing structure, and the side wall may completely cover at least three of the four side exterior surfaces and extends proud of the front cover. The rear wall and the side wall of the supplemental housing component may be formed from a unitary polymer structure.

A supplemental housing component for a mobile phone may include a rear wall configured to replace a removable rear cover assembly of a mobile phone, thereby defining a rear exterior surface of the mobile phone in place of the removable rear cover assembly of the mobile phone, a protective side wall extending from the rear wall and configured to cover at least a portion of a peripheral wall of a housing of the mobile phone, thereby defining a side exterior surface of the mobile phone, an attachment feature coupled to the rear wall and configured to attach to a corresponding attachment feature coupled to an interior side of the housing of the mobile phone, and an electrical connector configured to couple to a corresponding electrical connector within the housing of the mobile phone to electrically couple an electrical system of the supplemental housing component to the mobile phone. The rear wall may define a recess configured to receive a flange portion of a mobile phone housing therein.

The supplemental housing component may further include a supplemental flash configured to replace a flash coupled to the removable rear cover assembly of the mobile phone, a supplemental microphone configured to replace a microphone coupled to the removable rear cover assembly of the mobile phone, and a supplemental charging coil configured to replace a charging coil coupled to the removable rear cover assembly of the mobile phone, and the electrical connector may be configured to couple the supplemental flash, the supplemental microphone, and the supplemental charging coil to the mobile phone. The electrical connector may be attached to a flexible circuit element that extends from an interior side of the rear wall.

The removable rear cover assembly may include a rear cover formed of glass, and the rear wall of the supplemental housing component may be formed of a non-glass material. The rear wall may define a substantial entirety of a rear surface of the mobile phone.

A mobile phone may include a housing structure operable in a first assembly configuration in which a removable rear cover assembly is coupled to the housing structure to define a rear exterior surface of the mobile phone in the first assembly configuration, the housing structure defining a side exterior surface of the mobile phone in the first assembly configuration, and a second assembly configuration in which a supplemental housing component is coupled to the housing structure to define the rear exterior surface of the mobile phone in the second assembly configuration. The mobile phone may further include a first attachment feature coupled to the housing structure, a circuit board assembly at least partially within the housing structure, and a front cover assembly coupled to the housing structure. The removable rear cover assembly may include a rear cover formed of glass, a second attachment feature coupled to the first attachment feature in the first assembly configuration, thereby releasably coupling the removable rear cover assembly to the housing structure, and a first electrical connector conductively coupling the removable rear cover assembly to the circuit board assembly in the first assembly configuration. The supplemental housing component may include a rear wall configured to define the rear exterior surface of the mobile phone in the second assembly configuration, a side wall extending from the rear wall and configured to cover at least a portion of a peripheral wall of the mobile phone in the second assembly configuration, a third attachment feature configured to be coupled to the first attachment feature in the second assembly configuration, and a second electrical connector configured to conductively couple an electrical system of the supplemental housing component to the circuit board assembly in the second assembly configuration.

The mobile phone may further include a first waterproof seal between the removable rear cover assembly and the housing structure in the first assembly configuration, and a second waterproof seal between the supplemental housing component and the housing structure in the second assembly configuration. The first waterproof seal may be a first adhesive and the second waterproof seal may be a second adhesive.

The first attachment feature may be a spring clip, the spring clip may be conductively coupled to an electrical ground of the mobile phone, the second attachment feature may be a first metal tab extending from the rear wall of the removable rear cover assembly, the removable rear cover assembly may be conductively coupled to the electrical ground of the mobile phone via the first metal tab and the spring clip, the third attachment feature may be a second metal tab extending from the rear wall of the supplemental housing component, and the supplemental housing component may be conductively coupled to the electrical ground of the mobile phone via the second metal tab and the spring clip.

The mobile phone may further include, at least partially within the housing structure, a battery and a rear-facing camera array. In the second assembly configuration, an interior surface of the rear wall may be positioned directly opposite the circuit board assembly, the battery, and the rear-facing camera array. The removable rear cover assembly may include a camera window configured to cover a rear-facing camera of the mobile phone in the first assembly configuration. The supplemental housing component may include a supplemental camera window configured to cover the rear-facing camera of the mobile phone in the second assembly configuration.

A mobile phone may include a housing structure operable in a first assembly configuration in which a removable rear cover assembly is coupled to the housing structure to define a rear exterior surface of the mobile phone in the first assembly configuration, the housing structure defining a side exterior surface of the mobile phone in the first assembly configuration, and a second assembly configuration in which a supplemental housing component is coupled to the housing structure to define the rear exterior surface of the mobile phone and the side exterior surface of the mobile phone in the second assembly configuration. The mobile phone may further include a front cover formed of glass and coupled to the housing structure and defining at least a portion of a front exterior surface of the mobile phone in the first assembly configuration and the second assembly configuration a display below the front cover, an attachment feature coupled to the housing structure and configured to, in the first assembly configuration, engage with a first corresponding attachment feature of the removable rear cover assembly to mechanically couple the removable rear cover assembly to the housing and conductively couple the removable rear cover assembly to an electrical ground of the mobile phone, and in the second assembly configuration, engage with a second corresponding attachment feature of the supplemental housing component to mechanically couple the supplemental housing component to the housing and conductively couple the supplemental housing component to the electrical ground of the mobile phone. The mobile phone may further include a rear-facing camera including a lens configured to, in the first assembly configuration, extend into a first camera recess of the removable rear cover assembly, and in the second assembly configuration, extend into a second camera recess of the supplemental housing component, a circuit board assembly at least partially within the housing structure and including an electrical connector configured to, in the first assembly configuration, engage with a first corresponding electrical connector of the removable rear cover assembly to conductively couple the removable rear cover assembly to circuit board, and in the second assembly configuration, engage with a first corresponding electrical connector of the supplemental housing component to conductively couple the supplemental housing component to the circuit board.

### BRIEF DESCRIPTION OF THE DRAWINGS

The disclosure will be readily understood by the following detailed description in conjunction with the accompanying drawings, wherein like reference numerals designate like structural elements, and in which:

FIGS. 1 and 2 depict an example electronic device;

FIG. 3 depicts an exploded view of an example electronic device;

FIG. 4A depicts a partial exploded view of an example electronic device;

FIG. 4B depicts an exploded view of a portion of the electronic device of FIG. 4A;

FIG. 5A depicts an example electronic device with a removable rear cover assembly and a supplemental housing component;

FIG. 5B depicts a partial cross-sectional view of an example electronic device in a first assembly configuration with a rear cover assembly;

FIG. 5C depicts a partial cross-sectional view of an example electronic device in a second assembly configuration with an example supplemental housing component;

FIG. 5D depicts a partial cross-sectional view of an example electronic device in a second assembly configuration with another example supplemental housing component;

FIG. 6A depicts an example removable rear cover assembly for an electronic device;

FIG. 6B depicts an example supplemental housing component for an electronic device;

FIG. 7 depicts a spring clip system for an electronic device;

FIG. 8 depicts a system with an example set of supplemental housing components that may be usable in place of a removable rear cover assembly; and

FIG. 9 depicts a schematic diagram of an example electronic device.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

Mobile phones as described herein may include large complex, sophisticated components and systems that facilitate a multitude of functions. The mobile phones may also include housing structures that both enclose components of the mobile phone and also provide various operational functions. For example, mobile phones as described herein may include a band-like metal housing structure that defines the peripheral sides of the device and also acts as antennas for the device. Front and rear cover assemblies, which may each include a glass cover, may be attached to the housing structure to define the front and rear sides, respectively, of the housing. The front and rear glass covers may define the entire front and rear surfaces of the housing. The front and rear cover assemblies may include the glass covers, as well as various operational components attached thereto. For example, a front cover assembly may include a glass front cover, as well as a touch-screen display coupled to an interior side of the front cover. A rear cover assembly may include a glass rear cover, as well as a wireless charging coil, a flash, and a microphone coupled to the glass rear cover. The glass covers of the front and rear cover assemblies may be set into a rim or flange of the housing structure, such that the housing structure essentially surrounds the periphery of the glass covers (and thus covers and protects the edges of the glass).

The front and rear cover assemblies may be semi-permanently attached to the band-like housing structure. For example, the cover assemblies may be attached to the housing structure via clip mechanisms, which may both mechanically and conductively couple the cover assemblies to the housing structure. The cover assemblies may also be coupled to the housing structure with adhesives, which further enhance the strength of the coupling between the cover assemblies and the housing structure, and also provide an environmental seal between the cover assemblies and the housing structure. Fasteners, such as screws, bolts, or the like, may also secure the cover assemblies to the housing structure. The front and rear cover assemblies may be decoupled from the housing structure by removing any fasteners, debonding the cover assemblies from the housing structure (e.g., softening the adhesive or otherwise overcoming the adhesive force), and decoupling the clip mechanisms. Removing the cover assemblies may expose the internal components of the device (e.g., a battery, circuit board, etc.), and may facilitate the repair and/or replacement of the cover assemblies themselves, or the internal components of the device.

Mobile phones may sometimes be used with protective cases that cover some or all of the device housing with an additional shell or covering. Such cases can add bulk and weight to the device, and may reduce the effectiveness and/or the efficiency of device components that are positioned on the cover assemblies. For example, a rear cover assembly may include a wireless charging coil that wirelessly receives power from a charging accessory, as well as positioning magnets that align and/or retain the mobile phone to the charging accessory. The rear cover assembly may also include camera windows that are positioned directly over rear-facing cameras of the device. The addition of a protective case to such a device may reduce the efficiency and/or effectiveness of the charging coil and/or positioning magnets. Furthermore, the case may interfere with the field of view of the rear-facing cameras, or it may be provided with a large opening to avoid such interference (thereby introducing a potential weakness in the case and the protection that it can provide).

As described herein, a supplemental housing component may be provided that can be used in place of a removable rear cover assembly to both replace the rear cover, as well as to provide additional protective structures for the mobile phone. For example the supplemental housing component may include a rear wall that replaces the glass rear cover of the rear cover assembly (e.g., after the rear cover assembly is removed), as well as protective side walls that extend from the rear wall and cover (and optionally completely cover) the peripheral wall of the housing structure when the supplemental housing component is attached. The supplemental housing component thus provides protection to the device while eliminating redundant structures. Further, because the supplemental housing component is used instead of (and not in addition to) the rear cover assembly, the supplemental housing component may mechanically couple to the same attachment features as the rear cover assembly (e.g., the internal clips, fasteners, and the like, that the rear cover assembly were coupled to).

Additionally, the supplemental housing component may include supplemental versions of the same components that are included in the rear cover assembly, such as a supplemental charging coil, a supplemental flash, and a supplemental microphone. The supplemental housing component may thus also include an electrical connector that couples these (and optionally other) systems directly to the internal circuit board of the device. The supplemental housing components may also provide additional functionality, such as supplemental batteries, physiological sensors and/or health-monitoring devices, cameras, auxiliary displays, and the like.

The supplemental housing components described herein may provide a high degree of protection to a mobile phone, while also reducing redundant components, and providing a high degree of environmental sealing. These and other features are described herein.

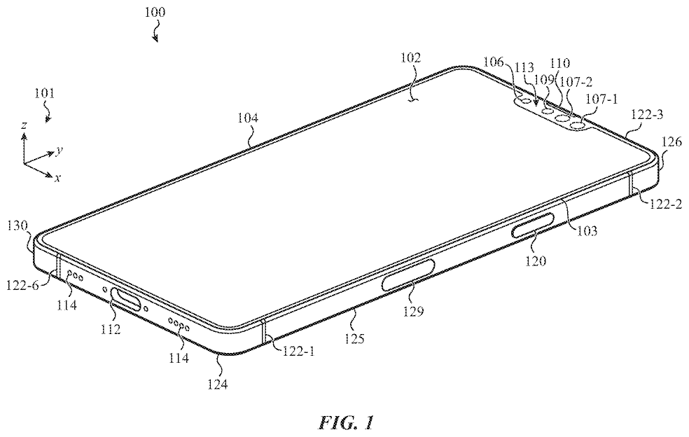

FIGS. 1 and 2 show an example electronic device 100 embodied as a mobile phone. FIG. 1 illustrates a front of the device 100, while FIG. 2 illustrates a back side of the device. While the device 100 is a mobile phone, the concepts presented herein may apply to any appropriate electronic devices, including portable electronic devices, wearable devices (e.g., watches), laptop computers, handheld gaming devices, tablet computers, computing peripherals (e.g., mice, touchpads, keyboards), or any other device. Accordingly, any reference to an “electronic device” encompasses any and all of the foregoing.

The electronic device 100 includes a cover 102 (e.g., a front cover) attached to a housing 104 (which may include a housing structure defined by one or more housing components). The cover 102 may be part of a front cover assembly, as described herein. The cover 102 may be positioned over a display 103. The cover 102 may be a sheet or sheet-like structure formed from or including a transparent or optically transmissive material. In some cases, the cover 102 is formed from or includes a glass material, and may therefore be referred to as a glass cover member. The glass material may be a silica-based glass material, an aluminosilicate glass, a boroaluminosilicate glass, an alkali metal aluminosilicate glass (e.g., a lithium aluminosilicate glass), or a chemically strengthened glass. Other example materials for the cover 102 include, without limitation, sapphire, ceramic, glass-ceramic, crystallizable glass materials, or plastic (e.g., polycarbonate). A glass-ceramic material may be a silica-based glass ceramic material, such as an aluminosilicate glass ceramic material or a boroaluminosilicate glass ceramic material. The glass-ceramic material may be chemically strengthened by ion exchange. The cover 102 may be formed as a monolithic or unitary sheet. The cover 102 may also be formed as a composite of multiple layers of different materials, coatings, and other elements.

The display 103 may be at least partially positioned within the interior volume of the housing 104. The display 103 may be coupled to the cover 102, such as via an adhesive or other coupling scheme. The display 103 may include a liquid-crystal display (LCD), a light-emitting diode (LED) display, an organic light-emitting diode (OLED) display, an active layer organic light emitting diode (AMOLED) display, an organic electroluminescent (EL) display, an electrophoretic ink display, or the like. The display 103 may be configured to display graphical outputs, such as graphical user interfaces, that the user may view and interact with. Graphical outputs may be displayed in a graphically active region of the display 103 (e.g., an active display region).

The device 100 may also include an ambient light sensor that can determine properties of the ambient light conditions surrounding the device 100. The ambient light sensor may be coupled to the cover 102 and/or part of the front cover assembly. The device 100 may use information from the ambient light sensor to change, modify, adjust, or otherwise control the display 103 (e.g., by changing a hue, brightness, saturation, or other optical aspect of the display based on information from the ambient light sensor). The device 100 may also include a proximity sensor (which may be coupled to the cover 102 and/or part of the front cover assembly) that can determine the proximity of an object (e.g., a user's face) to the device 100. The device 100 may use information from the proximity sensor to change, modify, adjust, or otherwise control the display 103 or other function of the device 100 (e.g., to deactivate the display when the device 100 is held near a user's face during a telephone call). The ambient light sensor and/or the proximity sensor may be positioned below an active area of the display 103 (e.g., below a portion of the display that produces graphical output). The ambient light sensor and/or the proximity sensor may transmit and/or receive light through the active area of the display 103 to perform sensing functions.

The display 103 may include or be associated with one or more touch- and/or force-sensing systems. In some cases, components of the touch- and/or force-sensing systems are integrated with the display stack. For example, touch-sensing components such as electrode layers of a touch and/or force sensor may be provided in a stack that includes display components (and is optionally attached to or at least viewable through the cover 102). The touch- and/or force-sensing systems may use any suitable type of sensing technology and touch-sensing components, including capacitive sensors, resistive sensors, surface acoustic wave sensors, piezoelectric sensors, strain gauges, or the like. The outer or exterior surface of the cover 102 may define an input surface (e.g., a touch- and/or force-sensitive input surface) of the device. While both touch- and force-sensing systems may be included, in some cases the device 100 includes a touch-sensing system and does not include a force-sensing system.

The device 100 may also include a front-facing camera 106. The front-facing camera 106 may be positioned below or otherwise covered and/or protected by the cover 102. The front-facing camera 106 may have any suitable operational parameters. For example, the front-facing camera 106 may include a 12 megapixel sensor (with 1 micron pixel size), and an 80-90° field of view. The front-facing camera 106 may have an aperture number of f/1.9. The front-facing camera 106 may include auto-focus functionality (e.g., one or more lens elements may move relative to an optical sensor to focus an image on the sensor). Other types of cameras may also be used for the front-facing camera 106, such as a fixed-focus camera.

The front-facing camera 106 (as well as other components) may be positioned in a front-facing sensor region 113 positioned in a notch-like area of the front of the device 100. In some cases, as described herein, the front-facing sensor region 113 may be positioned in or defined by a recessed area of the display (e.g., an area that is not occupied by the display or by a visually active portion of the display). In some cases, the front-facing sensor region 113 includes a mask or other visually opaque component or treatment that defines openings for the sensors. In some cases, one or more of the sensors or other devices in the front-facing sensor region 113 (e.g., the front-facing camera) are aligned with a hole formed through one or more layers of the display to provide optical access to the sensor. The front-facing sensor region 113 may include components such as a flood illuminator module 107-1, an infrared light projector 107-2, an infrared image capture device 109, and the front-facing camera 106.

The device 100 may also include one or more buttons (e.g., button 120, and buttons 116 in FIG. 1), switches (e.g., switch 118, FIG. 2), and/or other physical input systems. Such input systems may be used to control power states (e.g., the button 120), change speaker volume (e.g., the buttons 116), switch between “ring” and “silent” modes, and the like (e.g., the switch 118).

The device 100 may also include a speaker port 110 to provide audio output to a user, such as to a user's ear during voice calls. The speaker port 110, which is an example of an audio port, may also be referred to as a receiver, receiver port, or an earpiece in the context of a mobile phone. The speaker port 110 may be defined by an opening that is defined, along at least one side, by the housing 104, and along at least another side, by the cover 102. In some cases, the cover 102 defines a notch along an edge of the cover, and the notch (also referred to as a recess or cutout) defines at least three sides of the speaker port 110. In some cases, a protective grill or grate is positioned within the device 100 and in an audio path between a speaker and the speaker port 110 to inhibit ingress of debris into the device 100. The protective grill or grate may be flush with or recessed relative to the front surface or front face of the cover 102.

The device 100 may also include a charging port 112 (e.g., for receiving a connector of a power cable for providing power to the device 100 and charging the battery of the device 100). The device 100 may also include audio openings 114. The audio openings 114 may allow sound output from an internal speaker system (e.g., the speaker system 224, FIG. 2) to exit the housing 104. The device 100 may also include one or more microphones. In some cases, a microphone within the housing 104 may be acoustically coupled to the surrounding environment through an audio opening 114.

The housing 104 may be a multi-piece housing. For example, the housing 104 may be formed from multiple housing components 124, 125, 126, 127, 128, and 130, which are structurally coupled together via one or more intermediate elements, such as nonconductive joint structures 122 (e.g., 122-1-122-6). Together, the housing components 124, 125, 126, 127, 128, and 130 and the joint structures 122 may define a band-like housing structure that defines four sides (and thus four exterior side surfaces) about the periphery of the device 100. Thus, both the housing components and the joint structures define portions of the exterior side surfaces of the device 100.

The housing components 124, 125, 126, 127, 128, and 130 may be formed of a conductive material (e.g., a metal such as aluminum, stainless steel, or the like), and the joint structures 122 may be formed of one or more polymer materials (e.g., glass-reinforced polymer), and may be nonconductive. The joint structures 122 may include two or more molded elements, which may be formed of different materials. For example, an inner molded element may be formed of a first material (e.g., a polymer material), and an outer molded element may be formed of a second material that is different from the first (e.g., a different polymer material). The materials may have different properties, which may be selected based on the different functions of the inner and outer molded elements. For example, the inner molded element may be configured to make the main structural connection between housing components, and may have a higher mechanical strength and/or toughness than the outer molded element. On the other hand, the outer molded element may be configured to have a particular appearance, surface finish, chemical resistance, water-scaling function, or the like, and its composition may be selected to prioritize those functions over mechanical strength.

In some cases, one or more of the housing components 124, 125, 126, 127, 128, and 130 (or portions thereof) are configured to operate as antennas (e.g., components that are configured to transmit and/or receive electromagnetic waves to facilitate wireless communications with other computers and/or devices). To facilitate the use of the housing components as antennas, feed and ground lines may be conductively coupled to the housing components to couple the housing components to other antennas and/or communication circuitry. Further, the joint structures 122 may be substantially non-conductive to provide suitable separation and/or electrical isolation between the housing components (which may be used to tune the radiating portions, reduce capacitive coupling between radiating portions and other structures, and the like). In addition to the housing components 124, 125, 126, 127, 128, and 130, the device 100 may also include various internal antenna elements that are configured to transmit and receive wireless communication signals through various regions of the housing 104. As shown in FIG. 1, the device 100 may include an antenna window 129 that allows for the passage of radio-frequency communication signals through a corresponding region of the housing 104.

The joint structures 122 may be mechanically interlocked with the housing components to structurally couple the housing components and form a structural housing assembly.

The exterior surfaces of the housing components 124, 125, 126, 127, 128, and 130 may have substantially a same color, surface texture, and overall appearance as the exterior surfaces of the joint structures 122. In some cases, the exterior surfaces of the housing components 124, 125, 126, 127, 128, and 130 and the exterior surfaces of the joint structures 122 are subjected to at least one common finishing procedure, such as abrasive-blasting, machining, polishing, grinding, or the like. Accordingly, the exterior surfaces of the housing components and the joint structures may have a same or similar surface finish (e.g., surface texture, roughness, pattern, etc.). In some cases, the exterior surfaces of the housing components and the joint structures may be subjected to a two-stage blasting process to produce the target surface finish.

FIG. 1 also includes an example coordinate system 101 that may define directions with reference to the device 100 (or other electronic devices described herein). The coordinate system 101 defines a positive x direction, a positive y direction, and a positive z direction. Unless stated otherwise, references herein to a positive x, positive y, or positive z direction will be understood to refer generally to the coordinate system 101 and its relationship to the device 100 in FIG. 1. Negative x, y, and z directions will be understood to be opposite to the positive x, y, and z directions shown in the coordinate system in FIG. 1.

FIG. 2 illustrates a back side of the device 100. The device 100 may include a back or rear cover 132 coupled to the housing 104 and defining at least a portion of the exterior rear surface of the device 100. The rear cover 132 may be part of a rear cover assembly, as described herein.

The cover 102 (e.g., the front cover), the rear cover 132, and the housing 104 may define an enclosure of the device 100. The enclosure may define an internal volume in which components of the device 100 are positioned. The cover 102 (e.g., the front cover), the rear cover 132, and the housing 104 may also define substantially all of the exterior surfaces of the device 100 when the device is not being used with a supplemental housing component. For example, the front cover 102 may define substantially the entire front surface of the device, the housing 104 may define substantially the entire peripheral surface of the device, and the rear cover 132 may define substantially the entire rear surface of the device when the device is not being used with a supplemental housing component.

The rear cover 132 may be formed from or include a transparent or optically transmissive material. For example, the rear cover 132 may include a substrate formed of a glass material. The glass material may be a silica-based glass material, an aluminosilicate glass, a boroaluminosilicate glass, an alkali metal aluminosilicate glass (e.g., a lithium aluminosilicate glass), or a chemically strengthened glass. Other example materials for the rear cover 132 include, without limitation, sapphire, ceramic, glass-ceramic, crystallizable glass materials, and plastic (e.g., polycarbonate). A glass-ceramic material may be a silica-based glass ceramic material, such as an aluminosilicate glass ceramic material or a boroaluminosilicate glass ceramic material. The glass-ceramic material may be chemically strengthened by ion exchange. The rear cover 132 may be formed as a monolithic or unitary sheet. The rear cover 132 may also be formed as a composite of multiple layers of different materials, coatings, and other elements. The rear cover 132 may include one or more decorative layers on the exterior or interior surface of the substrate. For example, one or more opaque layers may be applied to the interior surface of the substrate (or otherwise positioned along the interior surface of the substrate) to provide a particular appearance to the back side of the device 100. The opaque layer(s) may include a sheet, ink, dye, or combinations of these (or other) layers, materials, or the like. In some cases the opaque layer(s) have a color that substantially matches a color of the housing 104 (e.g., the exterior surfaces of the housing components and the joint structures). The device 100 may include a wireless charging system, whereby the device 100 can be powered and/or its battery recharged by an inductive (or other electromagnetic) coupling between a charger and a wireless charging system within the device 100. In such cases, the rear cover 132 may be formed of a material that allows and/or facilitates the wireless coupling between the charger and the wireless charging system (e.g., glass).

The device 100 may also include a sensor array 134 (e.g., a rear-facing sensor array in a rear-facing sensor array region) that includes two (or optionally more or fewer) cameras. The sensor array 134 may be in a sensor array region that is defined by a protrusion 137 in a rear cover of the device 100. The protrusion 137 may define a portion of the rear exterior surface of the device 100, and may at least partially define a raised sensor array region of the sensor array 134. In some cases, the protrusion 137 may be formed by attaching a piece of material (e.g., glass) to another piece of material (e.g., glass). In other cases, the rear cover 132 may include a monolithic structure, and the protrusion 137 may be part of the monolithic structure. For example, the rear cover 132 may include a monolithic glass structure (or glass ceramic structure or alkali-aluminosilicate structure, or other suitable material) that defines the protrusion 137 as well as the surrounding area. In such cases, the protrusion 137 may be an area of increased thickness of the monolithic structure, or it may have a same or substantially same thickness as the rest of the cover (e.g., the protrusion 137 may correspond to or generally be opposite a recessed region along an interior side of the monolithic structure, such that the monolithic structure has a uniform thickness while also defining the protrusion 137).

The sensor array 134 may also include multiple cameras, such as a first camera 138 and a second camera 139. The first camera 138 may include a super-wide camera having a 12 megapixel sensor and a wide field of view (e.g., 120° FOV) optical stack with an aperture number of f/2.4; the second camera 139 may include a wide view camera having a 12 megapixel sensor and an aperture number of f/1.6. In some cases, the sensor array 134 may include a telephoto lens having a 12 megapixel sensor with a 3× optical zoom optical stack having an aperture number ranging from f/2.0 to f/2.8 (e.g., in addition to the first and second cameras 138, 139, or in place of one of the first or second cameras). One or more of the cameras (e.g., cameras 138, 139) of the sensor array 134 may also include optical image stabilization, whereby the lens is dynamically moved relative to a fixed structure within the device 100 to reduce the effects of “camera shake” on images captured by the camera. The camera(s) may also perform optical image stabilization by moving the image sensor relative to a fixed lens or optical assembly. One or more of the cameras may include autofocus functionality, in which one or more lens elements (and/or sensors) are movable to focus an image on a sensor. The sensor array 134 may also include a flash 136 (e.g., a rear-facing flash). The flash 136 may include a multi-segment LED or a single LED or other light emitting component.

The sensor array 134, along with associated processors and software, may provide several image-capture features. For example, the sensor array 134 may be configured to capture full-resolution video clips of a certain duration each time a user captures a still image. As used herein, capturing full-resolution images (e.g., video images or still images) may refer to capturing images using all or substantially all of the pixels of an image sensor, or otherwise capturing images using the maximum resolution of the camera (regardless of whether the maximum resolution is limited by the hardware or software).

The captured video clips may be associated with the still image. In some cases, users may be able to select individual frames from the video clip as the representative still image associated with the video clip. In this way, when the user takes a snapshot of a scene, the camera will actually record a short video clip (e.g., 1 second, 2 seconds, or the like), and the user can select the exact frame from the video to use as the captured still image (in addition to simply viewing the video clip as a video).

The cameras of the sensor array 134 may also have or provide a high-dynamic-range (HDR) mode, in which the camera captures images having a dynamic range of luminosity that is greater than what is captured when the camera is not in the HDR mode. In some cases, the sensor array 134 automatically determines whether to capture images in an HDR or non-HDR mode. Such determination may be based on various factors, such as the ambient light of the scene, detected ranges of luminosity, tone, or other optical parameters in the scene, or the like. HDR images may be produced by capturing multiple images, each using different exposure or other image-capture parameters, and producing a composite image from the multiple captured images.

The cameras of the sensor array 134 may also include software-based color balance correction. For example, when a flash (e.g., the flash 136) is used during image capture, the cameras (and/or associated processing functionality of the device 100) may adjust the image to compensate for differences in color temperature between the flash output and the ambient lighting in the image. Thus, for example, if a background of an image has a different color temperature than a foreground subject (e.g., because the foreground subject is illuminated by the flash output), the cameras may modify the background and/or the foreground of the image to produce a more consistent color temperature across the image.

The sensor array 134 may also include or be configured to operate in an object detection mode, in which a user can select (and/or the device 100 can automatically identify) objects within a scene to facilitate those objects being processed, displayed, or captured differently than other parts of the scene. For example, a user may select (or the device 100 may automatically identify) a person's face in a scene, and the device 100 may focus on the person's face while selectively blurring the portions of the scene other than the person's face. Notably, features such as the HDR mode and the object detection mode may be provided with a single camera (e.g., a single lens and sensor).

The sensor array 134 may also include a microphone 135. The microphone 135 may be acoustically coupled to the exterior environment through a hole defined in the rear cover of the device 100 (e.g., through the portion of the rear cover that defines the protrusion 137). As described herein, the microphone 135 and the flash 136 may be part of a rear cover assembly (e.g., coupled to the rear cover), and may be electrically coupled to the circuit board assembly of the device 100 via an electrical connector.

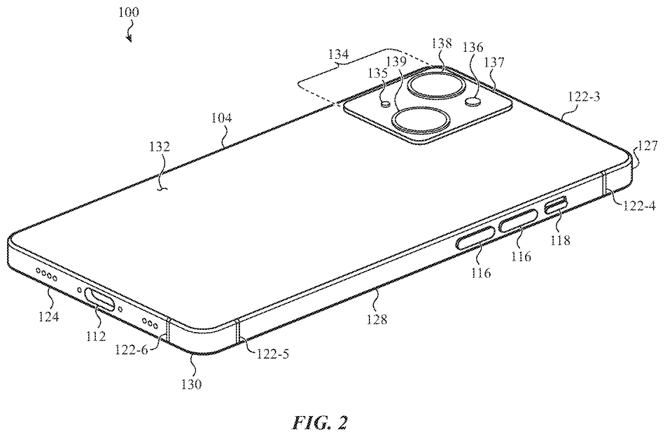

FIG. 3 depicts an exploded view of an example electronic device. In particular, FIG. 3 depicts an exploded view of a device 300, showing various components of the device 300 and example arrangements and configurations of the components. The device 300 may be an embodiment of the device 100, and the description of the various components and elements of device 100 of FIGS. 1-2 may also be applicable to the device 300 depicted in FIG. 3. A redundant description of some of the components is not repeated herein for clarity.

As shown in FIG. 3, the device 300 includes a cover 302 (e.g., a front cover), which may be formed from or include a transparent or optically transmissive material. In some cases, the cover 302 is formed from or includes a glass material or other suitable transparent or optically transmissive material (e.g., a silica-based glass material, an aluminosilicate glass, a boroaluminosilicate glass, an alkali metal aluminosilicate glass, a chemically strengthened glass, sapphire, ceramic, glass-ceramic, crystallizable glass materials, or plastic). In this example, the cover 302 may be formed from a glass-ceramic material. A glass-ceramic material may include both amorphous and crystalline or non-amorphous phases of one or more materials and may be formulated to improve strength or other properties of the cover 302. A glass-ceramic material may be a silica-based glass ceramic material, such as an aluminosilicate glass ceramic material or a boroaluminosilicate glass ceramic material. The glass-ceramic material may be chemically strengthened by ion exchange. In some cases, the cover 302 may include a sheet of chemically strengthened material having one or more coatings including an anti-reflective (AR) coating, an oleophobic coating, or other type of coating or optical treatment. In some cases, the cover 302 includes a sheet of material that is less than 1 mm thick. In some cases, the sheet of material is less than 0.80 mm. In some cases, the sheet of material is approximately 0.60 mm or less. The cover 302 may be chemically strengthened using an ion exchange process to form a compressive stress layer along exterior surfaces of the cover 302.

The cover 302 extends over a substantial entirety of the front surface of the device and may be positioned within an opening defined by the housing structure 310. In some cases, the edges or sides of the cover 302 may be surrounded by a protective flange or lip of the housing structure 310 without an interstitial component between the edges of the cover 302 and the respective flanges of the housing structure 310. This configuration may allow an impact or force applied to the housing structure 310 to be transferred to the cover 302 without directly transferring shear (or other) stress through the display 303 or frame 304.

As shown in FIG. 3, the display 303 is attached to an internal surface of the cover 302. The display 303 may include an edge-to-edge organic light emitting diode (OLED) display that measures 15.4 cm (6.1 inches) corner-to-corner. The perimeter or non-active area of the display 303 may be reduced to allow for very thin device borders around the active area of the display 303. In some cases, the display 303 allows for border regions of 1.5 mm or less. In some cases, the display 303 allows for border regions of 1 mm or less. In one example implementation, the border region is approximately 0.9 mm. The display 303 may have a relatively high pixel density of approximately 460 pixels per inch (PPI) or greater. In some cases, the display 303 has a pixel density of approximately 475 PPI. The display 303 may have an integrated (on-cell) touch-sensing system. For example, an array of electrodes (or other touch-sensing components) that are integrated into the OLED display may be time and/or frequency multiplexed in order to provide both display and touch-sensing functionality. The electrodes may be configured to detect a location of a touch, a gesture input, multi-touch input, or other types of touch input along the external surface of the cover 302. In some cases, the display 303 includes another type of display element, such as a liquid-crystal display (LCD) without an integrated touch-sensing system. That is, the device 300 may include one or more touch- and/or force-sensing components or layers that are positioned between the display 303 and the cover 302.

The display 303, also referred to as a display stack, may include always-on-display (AOD) functionality. For example, the display 303 may be configurable to allow designated regions or subsets of pixels to be displayed when the device 300 is powered on such that graphical content is visible to the user even when the device 300 is in a low-power or sleep mode. This may allow the time, date, battery status, recent notifications, and other graphical content to be displayed in a lower-power or sleep mode. This graphical content may be referred to as persistent or always-on graphical output. While some battery power may be consumed when displaying persistent or always-on graphical output, the power consumption is typically less than during normal or full-power operation of the display 303. This functionality may be enabled by only operating a subset of the display pixels and/or at a reduced resolution in order to reduce power consumption by the display 303.

The display 303 may include multiple layers, including touch-sensing layers or components, optional force-sensing layers or components, display layers, and the like. The display 303 may define a graphically active region in which graphical outputs may be displayed. In some cases, portions of the display 303 may include graphically inactive regions, such as portions of the display layers that do not include active display components (e.g., pixels) or are otherwise not configured to display graphical outputs. In some cases, graphically inactive regions may be located along the peripheral borders or other edges of the display stack 303.

As shown in FIG. 3, the device 300 may also include a frame member 304, also referred to simply as a frame 304, that is positioned below the cover 302 and that extends around an outer periphery of the display 303. A perimeter of the frame 304 may be attached to a lower or inner surface of the cover 302. A portion of the frame 304 may extend below the display 303 and may attach the cover 302 to the housing structure 310. Because the display 303 is attached to a lower or inner surface of the cover 302, the frame 304 may also be described as attaching both the display 303 and the cover 302 to the housing structure 310. The frame 304 may be formed of a polymer material, a metal material, or a combination of polymer and metal materials. The frame 304 may support elements of the display stack, provide anchor points for flexible circuits, and/or be used to mount other components and device elements. In some cases, the frame 304 includes one or more metal or conductive elements that provide shielding between device components, such as between the display stack (including display components and touch sensor components) and other components like the haptic actuator 322, the speaker system 324, and the like.

The cover 302, display or display stack 303, and frame member 304 may be part of a front cover assembly 301 of the device 300. The front cover assembly 301 (e.g., a front cover of the front cover assembly) may define a front exterior surface of the device. The front cover assembly 301 may be assembled as a subassembly, which may then be attached to a housing component. For example, as described herein, the display 303 may be attached to the cover 302 (e.g., via a transparent adhesive), and the frame member 304 may be attached (e.g., via adhesive) to the cover around a periphery of the display stack 303. The front cover assembly 301 may then be attached to a housing component of the device 300 by mounting and adhering the frame member 304 to a ledge defined by the housing component.

The device 300 also includes a speaker module 350 that is configured to output sound via a speaker port. The speaker port may be positioned in and/or at least partially defined by a recess 351 of the cover 302. A trim piece may be positioned at least partially in the recess 351 to facilitate the output of sound while also inhibiting the ingress of debris, liquid, or other materials or contaminants into the device 300. Output from the speaker module 350 may pass through an audio passage or acoustic path defined at least in part by the speaker module 350 itself and the trim piece. In some cases, part of the acoustic path (e.g., between the speaker module 350 and the trim piece) is defined by the housing structure 310 and/or a molded material that is coupled to the housing structure 310. For example, a molded material (e.g., a fiber-reinforced polymer) may be molded against a metal portion of the housing structure 310 (e.g., the housing component 313). The molded material may also form one or more intermediate elements, such as joint structures, that also structurally join housing components together (e.g., the joint structures 318). A port or passage (e.g., a tube-like tunnel) may be defined through the molded material to acoustically couple the speaker module 350 to the trim piece and/or the recess 351 more generally, thereby directing sound from the speaker module 350 to the exterior of the device 300.

As shown in FIG. 3, the device 300 also includes one or more cameras, optical emitters, and/or sensing elements that are configured to transmit signals, receive signals, or otherwise operate along the front surface of the device. In this example, the device 300 includes a front camera 306 that includes a high-resolution camera sensor. The front camera 306 may have a 12 megapixel resolution sensor with optical elements that provide an 85° field of view. The front camera 306 may have an aperture number of f/1.9. The front camera 306 may include autofocus functionality in which one or more of the lens elements move (e.g., up to about 100 microns perpendicular to the cover) in order to focus an image on the camera's sensor. In some cases, the autofocusing front-facing camera is capable of providing continuous autofocus functionality during video capture. The device 300 also includes an optical facial recognition system 352 that includes an infrared light projector and infrared light sensor that are configured to sense an array of depth points or regions along the face of the user. The array of depth points may be characterized as a unique signature or bio-identifier, which may be used to identify the user and unlock the device 300 or authorize functionality on the device 300 like the purchase of software apps or the use of payment functionality provided by the device 300.

The device 300 may also include one or more other sensors or components. For example, the device 300 may include a front light illuminator element for providing a flash or illumination for the front camera 306. The device 300 may also include an ambient light sensor (ALS) that is used to detect ambient light conditions for setting exposure aspects of the front camera 306 and/or for controlling the operation of the display.

FIG. 3 also illustrates one or more cameras, optical emitters, and/or sensing elements that are configured to transmit signals, receive signals, or otherwise operate along the rear surface of the device. As depicted in FIG. 3, these elements may be part of a sensor array 360. In this example, the sensor array 360 includes a first camera 361 having a 12 megapixel image sensor and a wide angle lens with an aperture number of f/1.6. The first camera 361 may also include a dual photodiode sensor having an APS+ sensor format. The sensor array 360 may also include a second camera 362 having a 12 megapixel image sensor and a super-wide angle lens (120° FOV) with an aperture number of f/2.4. The sensor array 360 also includes a flash or other light illuminator (e.g., the flash 136) that may be used as a flash for photography or as an auxiliary light source (e.g., a flashlight). In some cases, the sensor array 360 also includes a microphone (e.g., the microphone 135), an ambient light sensor, a depth sensing device, and/or other sensors that are adapted to sense along the rear surface of the device 300.

As shown in FIG. 3, the cameras 361 and 362 may be aligned with camera covers 363 and 364, respectively. The covers 363, 364 (which may also be referred to as camera windows) may be formed from a glass, glass-ceramic, or sapphire material and may provide a clear (e.g., transparent or optically transmissive) window through which the cameras 361, 362 are able to capture a photographic image. In other cases, the covers 363, 364 are optical lenses that filter, magnify, or otherwise condition light received by the respective camera 361, 362. The other sensing or transmitting elements of the sensor array 360 may transmit and/or receive signals through a region of the rear cover 372 or through a separate cover that is coupled to the rear cover 372. As shown in FIG. 3, the covers 363, 364 may extend beyond the exterior surface of the cover 372, and may define a recess along the interior side of the cover 372, such that the lens or other element of the cameras 361 and 362 can extend into the respective recesses. In this way, the device 300 may accommodate a larger lens or other elements of the cameras 361 and 362 than would be possible if the recess were not provided. In some cases, trim assemblies 365, 366 may be coupled to the cover 372 and may support the covers 363, 364. The covers 363, 364 and the trim assemblies 365, 366 may be attached to the cover 372 and may be part of a rear cover assembly 373 that can be removed and replaced with a supplemental housing component as described herein.

The device 300 also includes a battery 330. The battery 330 provides electrical power to the device 300 and its various systems and components. The battery 330 may include a 4.40 V lithium ion battery that is encased in a foil or other enclosing element. The battery 330 may include a rolled electrode configuration, sometimes referred to as a “jelly roll” or a folded or stacked electrode configuration. The battery 330 may be recharged via the charging port 332 (e.g., from a power cable plugged into the charging port 332 through a charging access opening 326), and/or via a wireless charging system 340. The battery 330 may be coupled to the charging port 332 and/or the wireless charging system 340 via battery control circuitry that controls the power provided to the battery and the power provided by the battery to the device 300. The battery 330 may include one or more lithium ion battery cells or any other suitable type of rechargeable battery element.

The wireless charging system 340 may include a coil that inductively couples to an output or transmitting coil of a wireless charger. The coil may provide current to the device 300 to charge the battery 330 and/or power the device. In this example, the wireless charging system 340 includes a coil assembly 342 that includes multiple wraps of a conductive wire or other conduit that is configured to produce a (charging) current in response to being placed in an inductive charging electromagnetic field produced by a separate wireless charging device or accessory. The coil assembly 342 also includes an array of magnetic elements that are arranged in a circular or radial pattern. The magnetic elements may help to locate the device 300 with respect to a separate wireless charging device or other accessory. In some implementations, the array of magnets also help to radially locate, orient, or “clock” the device 300 with respect to the separate wireless charging device or other accessory. For example, the array of magnets may include multiple magnetic elements having alternating magnetic polarity that are arranged in a radial pattern. The magnetic elements may be arranged to provide a magnetic coupling to the separate charging device in a particular orientation or set of discrete orientations to help locate the device 300 with respect to the separate charging device or other accessory. This functionality may be described as self-aligning or self-locating wireless charging. As shown in FIG. 3, the device 300 also includes a magnetic fiducial 344 for helping to locate the separate wireless charging device or accessory. In one example, the magnetic fiducial 344 is adapted to magnetically couple to a cable or power cord of the separate wireless charging device or other accessory. By coupling to the cable or power cord, the rotational alignment of the device 300 and the separate wireless charging device or other accessory may be maintained with respect to an absolute or single position. Also, by magnetically coupling the cable or cord to the rear surface of the device 300, the charging device or other accessory may be more securely coupled to the device 300.

In some implementations, the wireless charging system 340 includes an antenna or other element that detects the presence of a charging device or other accessory. In some cases, the charging system includes a near-field communications (NFC) antenna that is adapted to receive and/or send wireless communications between the device 300 and the wireless charger or other accessory. In some cases, the device 300 is adapted to perform wireless communications to detect or sense the presence of the wireless charger or other accessory without using a dedicated NFC antenna. The communications may also include information regarding the status of the device, the amount of charge held by the battery 330, and/or control signals to increase charging, decrease charging, start charging and/or stop charging for a wireless charging operation. The wireless charging system 340, including attachment and/or alignment magnets, charging coils, and the like, may be attached to the cover 372 and may be part of a rear cover assembly 373 that can be removed and replaced with a supplemental housing component as described herein.

The device 300 may also include a speaker system 324. The speaker system 324 may be positioned in the device 300 so that a respective port 325 is aligned with or otherwise proximate an audio output of the speaker system 324. Accordingly, sound that is output by the speaker system 324 exits the housing structure 310 via the respective port 325. The speaker system 324 may include a speaker positioned in a housing that defines a speaker volume (e.g., an empty space in front of or behind a speaker diaphragm). The speaker volume may be used to tune the audio output from the speaker and optionally mitigate destructive interference of the sound produced by the speaker.

The device 300 may also include a haptic actuator 322. The haptic actuator 322 may include a movable mass and an actuation system that is configured to move the mass to produce a haptic output. The actuation system may include one or more coils and one or more magnets (e.g., permanent and/or electromagnets) that interact to produce motion. The magnets may be or may include recycled magnetic material.

When the coil(s) are energized, the coil(s) may cause the mass to move, which results in a force being imparted on the device 300. The motion of the mass may be configured to cause a vibration, pulse, tap, or other tactile output detectable via an exterior surface of the device 300. The haptic actuator 322 may be configured to move the mass linearly, though other movements (e.g., rotational) are also contemplated. Other types of haptic actuators may be used instead of or in addition to the haptic actuator 322.

The device 300 also includes a circuit board assembly 320 (which may also be referred to as a circuit board assembly). The circuit board assembly 320 may include a substrate, and processors, memory, and other circuit elements coupled to the substrate. The circuit board assembly 320 may include multiple circuit substrates that are stacked and coupled together in order to maximize the area available for electronic components and circuitry in a compact form factor. The circuit board assembly 320 may include provisions for a subscriber identity module (SIM). The circuit board assembly 320 may include electrical contacts and/or a SIM tray assembly for receiving a physical SIM card and/or the circuit board assembly 320 may include provisions for an electronic SIM. The circuit board assembly 320 may be wholly or partially encapsulated to reduce the chance of damage due to ingress of water or other fluid.

The circuit board assembly 320 may be thermally coupled to a mid-chassis section 323 of the housing structure 310. As described herein, the mid-chassis section 323, also referred to simply as a chassis 323, may be part of a housing component 314 (e.g., a middle housing component) that is formed from a unitary structure and that defines the chassis 323 as well as a first wall section 317 that defines a first side exterior surface of the device 300, and a second wall section 319 that defines a second side exterior surface of the device 300. The circuit board assembly 320 may be thermally coupled to the chassis 323 via one or more thermal bridges, such as a graphite structure, a graphite-wrapped foam, or other thermally conductive structure(s). Heat from the circuit board assembly may be transferred to the chassis 323 via the thermal bridges, thereby removing heat from the circuit board assembly 320 (where heat may be detrimental to durability, performance, or the like), and also drawing heat away from exterior surfaces and/or components of the device 300 that come into contact with a user (e.g., the wall sections 317, 319, which define exterior side surfaces of the device and which may be held by a user when the device 300 is in use).

The circuit board assembly 320 may also include wireless communication circuitry, which may be operably coupled to and/or otherwise use the wall sections and/or housing components 312, 313, 317, 315, 316, or 319 (or portions thereof) as radiating members or structures to provide wireless communications. The circuit board assembly 320 may also include components such as accelerometers, gyroscopes, near-field communications circuitry and/or antennas, compasses, and the like. In some implementations, the circuit board assembly 320 may include a magnetometer that is adapted to detect and/or locate an accessory. For example, the magnetometer may be adapted to detect a magnetic (or non-magnetic) signal produced by an accessory of the device 300 or other device. The output of the magnetometer may include a direction output that may be used to display a directional indicia or other navigational guidance on the display 303 in order to guide the user toward a location of the accessory or other device.

The device 300 may also include one or more pressure transducers that may be operable to detect changes in external pressure in order to determine changes in altitude or height. The pressure sensors may be externally ported and/or positioned within a water-sealed internal volume of the housing structure 310. The output of the pressure sensors may be used to track flights of stairs climbed, a location (e.g., a floor) of a multi-story structure, movement performed during an activity in order to estimate physical effort or calories burned, or other relative movement of the device 300.

The circuit board assembly 320 may also include global positioning system (GPS) electronics that may be used to determine the location of the device 300 with respect to one or more satellites (e.g., a Global Navigation Satellite System (GNSS)) in order to estimate an absolution location of the device 300. In some implementations, the GPS electronics are operable to utilize dual frequency bands. For example, the GPS electronics may use L1 (L1C), L2 (L2C), L5, L1+L5, and other GPS signal bands in order to estimate the location of the device 300.

As shown in FIG. 3, the housing may include a cover 372 (e.g., rear or rear cover) that may define a substantial entirety of the rear surface of the device 300. The rear cover 372, the front cover 302, and the housing structure 310 may at least partially define an enclosure of the device 300, which may define an internal volume in which components of the device 300 are positioned. The cover 372 may be formed from or include a transparent or optically transmissive material. For example, the cover 372 may include a substrate formed from or including a glass material or other suitable material (e.g., a silica-based glass material, an aluminosilicate glass, a boroaluminosilicate glass, an alkali metal aluminosilicate glass, a chemically strengthened glass, sapphire, ceramic, glass-ceramic, crystallizable glass materials, or plastic). A glass-ceramic material may be a silica-based glass ceramic material, such as an aluminosilicate glass ceramic material or a boroaluminosilicate glass ceramic material. The glass-ceramic material may be chemically strengthened by ion exchange. The substrate may have portions that are less than 1 mm thick. In some cases, the substrate has portions that are less than 0.80 mm. In some cases, the substrate has portions that are approximately 0.60 mm or less. The cover 372 may have a uniform thickness or, in some cases, may have a thickened or raised portion that surrounds the camera covers 363, 364. The cover 372 may be machined (e.g., ground) into a final shape before being polished and/or textured to provide the desired surface finish. The texture may be specially configured to provide a matte appearance while also being resistant to collecting a buildup of skin, lint, or other debris. A series of cosmetic layers may be formed along the inner surface of the cover 372 to provide a desired optical effect and final color of the device 300.

The cover 372 may be part of a removable rear cover assembly 373. The removable rear cover assembly 373 may be coupled to the housing structure 310, and may be configured to be removed so that the rear cover assembly 373 can be replaced with a supplemental housing component to provide different or additional functionality to the device 100, as well as provide additional physical protection to the device 100. In some cases, the rear cover assembly 373 includes components such as rear-facing camera windows 363 and 364, trim assemblies 365, 366, structural components (e.g., frames), trim assemblies, and mounting features (e.g., clips or tabs). In some cases, the rear cover assembly 373 includes electrical components and/or systems that are electrically coupled to the circuit board assembly or other electronic components within the device 100. For example, the flash 136, the microphone 135, and components of the wireless charging system 340 may be coupled to the rear cover 372 and part of the rear cover assembly 373. Accordingly, the rear cover assembly 373 may include an electrical connector that conductively couples the rear cover assembly 373, and its electrical components and/or systems, to the circuit board assembly of the device. For example, the rear cover assembly 373 may include a flexible circuit element that extends from the rear cover assembly 373 and includes a first connector component that couples to a corresponding second connector component on the circuit board assembly. The flexible circuit element may facilitate case of removal and attachment of the removable rear cover assembly 373 to the rest of the device, as the rear cover assembly 373 can be physically removed before decoupling the electrical connectors, and because the flexible circuit element can accommodate for any misalignments between the rear cover assembly 373 and the circuit board assembly.

Similar to as described above with respect to cover 302, the cover 372 may be positioned at least partially within an opening defined in the housing structure 310. Also similar to as described above with respect to cover 302, the edges or sides of the cover 372 may be surrounded by a protective flange or lip of the housing structure 310 without an interstitial component between the edges of the cover 372 and the respective flanges of the housing structure 310. The cover 372 may be chemically strengthened using an ion exchange process to form a compressive stress layer along exterior surfaces of the cover 372. In some cases, the (rear) cover 372 is formed from the same or a similar material as (front) cover 302.

The housing structure 310 may include a housing component 314 (e.g., a middle housing component 314) that includes the wall sections 317 and 319 and the mid-chassis section 323 (e.g., a metal plate-like structure that extends between the wall sections 317 and 319). The chassis 323 may define a mounting structure for components of the device 300. For example, as described herein, components such as the circuit board assembly 320, battery 330, sensor array 360, receiver 350, speaker module 324, haptic actuator 322, and the like, may be coupled to the chassis 323 (e.g., along a rear-facing side of the chassis 323). By coupling components to the chassis 323 instead of the front cover assembly 301 and/or the rear cover 372, the cost and complexity of the front cover assembly 301 and rear cover assembly 373 may be reduced, and removal and/or replacement of the front cover assembly 301 and/or rear cover 372 may be simplified. The chassis 323 may also define one or more holes extending therethrough to facilitate the coupling of components on one side of the chassis 323 (e.g., the display 303 and/or sensors of the front cover assembly 301) to components on the other side of the chassis 323 (e.g., the circuit board assembly 320). Additionally, as noted above, the chassis 323 may also be thermally coupled to components of the device 300, such as the circuit board assembly 320, to conduct heat away from the thermally coupled components.

The housing component 314 may be a unitary structure formed from a single piece of material. For example, the unitary structure of the housing component 314 may be a metal, such as aluminum, steel, titanium, or the like and may be formed by extrusion, machining, and/or combinations of these and other forming processes. Thus, the wall sections 317 and 319 (which define side exterior surfaces of the device 300) and the chassis 323 may be different portions of a single piece of material. In some cases the housing component 314 is formed of a polymer material, reinforced polymer material (e.g., fiber reinforced), carbon fiber, or other suitable material.

As described above, the housing structure 310 may include housing components 312, 313, 315, and 316 structurally joined together and/or to the housing component 314 (the middle housing component 314) via joint structures 318. The joint structures 318 (e.g., the material of the joint structures) may extend over inner surfaces of the housing components. More particularly, a portion of the joint structures 318 may contact, cover, encapsulate, and/or engage with retention features of the housing components that extend from the inner surfaces of the housing components (including, for example, from the wall sections of the middle housing component 314). As the wall sections 317 and 319 are part of a single unitary structure, the joint structures 318 may also function to structurally join the housing components 312, 313, 315, and 316 to the housing component 314. When coupled via the joint structures 318, the housing component 314, the housing components 312, 313, 315, and 316, and the joint structures 318 may define a main housing assembly that defines the exterior side surfaces of the device 300 as well as the chassis 323 within the device.

Housing components 312, 313, 315, and 316 may also be referred to herein as housing segments and may be formed from aluminum, stainless steel, or other metal or metal alloy material. The housing components 312, 313, 315, and 316, and the wall sections 317, 319, may provide a robust and impact resistant sidewall for the device 300. In the present example, the housing components 312, 313, 315, and 316 and the wall sections 317, 319 define a flat sidewall that extends around the perimeter of the device 300. The flat sidewall may include rounded or chamfered edges that define the upper and lower edges of the sidewall of the housing structure 310. The housing components 312, 313, 315, and 316 and the wall sections 317, 319 may each have a flange portion or lip that extends around and at least partially covers a respective side of the front and rear covers 302, 372. There may be no interstitial material or elements between the flange portion or lip and the respective side surface of the front and rear covers 302, 372. This may allow forces or impacts that are applied to the housing structure 310 to be transferred to the front and rear covers 302, 372 without affecting the display or other internal structural elements, which may improve the drop performance of the device 300.

As shown in FIG. 3, the device 300 includes multiple antennas that may be adapted to conduct wireless communication using a 5G communication protocol. In particular, the device 300 may include a (side-fired) antenna array 382 that is configured to transmit and receive wireless communication signals through an antenna window 383 or waveguide formed along or otherwise integrated with the side of the housing structure 310. The side-fired antenna array 382 may be coupled to the circuit board assembly 320 via a flexible circuit element or other conductive connection. The device 300 may also include a rear antenna module that may include one or more (rear-fired) antenna arrays that may be configured to transmit and receive wireless communication signals through the cover 372. The antenna module may be attached to a back or bottom surface of the circuit board assembly 320.

The antenna modules may include multiple antenna arrays. For example, the antenna modules may include one or more millimeter-wave antenna arrays. In the case where the antenna modules include multiple millimeter-wave antenna arrays (each of which may include one or more radiating elements), the multiple millimeter-wave antenna arrays may be configured to operate according to a diversity scheme (e.g., spatial diversity, pattern diversity, polarization diversity, or the like). The antenna modules may also include one or more ultra-wideband antennas.

Each of the antenna arrays (e.g., the antenna array 382 and the millimeter-wave arrays of the antenna module) may be adapted to conduct millimeter wave 5G communications and may be adapted to use or be used with beam-forming or other techniques to adapt signal reception depending on the use case. The device 300 may also include multiple antennas for conducting multiple-in multiple-out (MIMO) wireless communications schemes, including 4G, 4G LTE, and/or 5G MIMO communication protocols. One or more of the housing components 312, 313, 315, and 316 and the wall sections 317, 319 (or portions thereof) may be adapted to operate as antennas for a MIMO wireless communication scheme (or other wireless communication scheme).

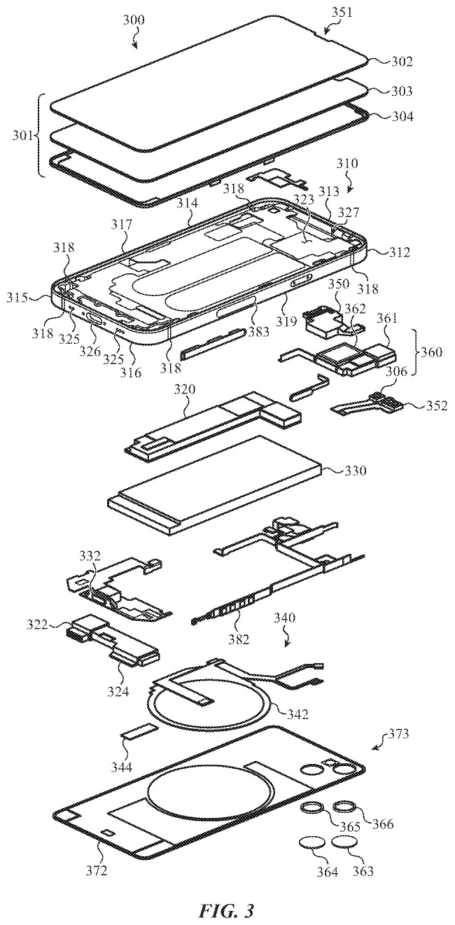

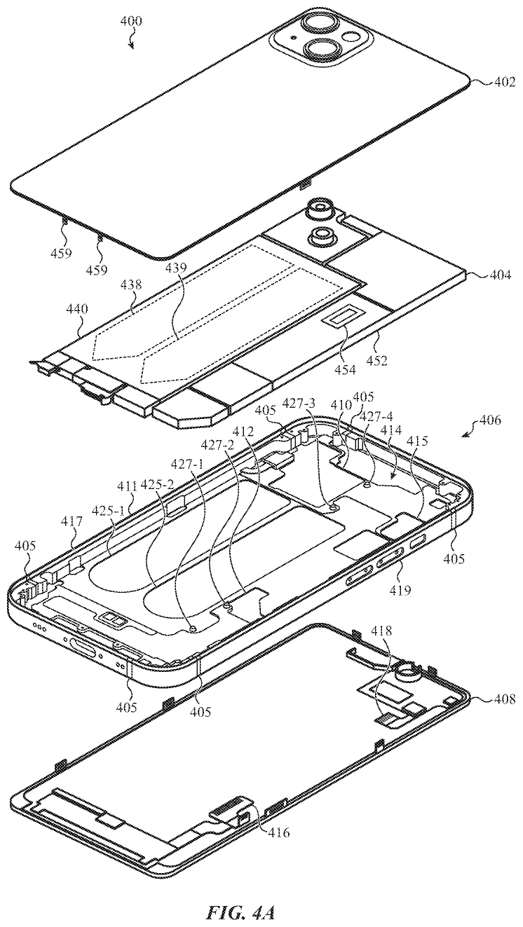

FIG. 4A depicts a partial exploded view of an example electronic device 400. The electronic device 400 may correspond to or be an embodiment of the electronic devices 100, 300, or any other device described herein.

As shown in FIG. 4A, the device 400 may include an enclosure that defines an interior cavity and includes a rear cover assembly 402 (e.g., a removable rear cover assembly 402), a housing structure 406, and a front cover assembly 408. The front cover assembly 408 may define a front exterior surface of the enclosure (e.g., substantially the entire front exterior surface), and the rear cover assembly 402 may define a rear exterior surface of the device (e.g., substantially the entire rear exterior surface). In some cases, the peripheries of the front cover assembly and the rear cover assembly are each surrounded by a flange or rim defined by the housing structure. The housing structure 406 may be positioned generally between the front cover assembly 408 and the rear cover assembly 402.

The housing structure 406 includes a middle housing component 410 as well as housing components 420, 421, 422, and 423 (FIG. 4B). The middle housing component 410, which may correspond to or be an embodiment of the housing component 314, includes a mid-chassis section 428, as well as wall sections 417, 419. As described above with respect to the housing component 314, the housing component 410 may be a unitary structure formed from a single piece of material. For example, the unitary structure of the housing component 410 may be a metal, such as aluminum, steel, titanium, or the like and may be formed by extrusion, machining, and/or combinations of these and other forming processes. Thus, the wall sections 417 and 419 (which define side exterior surfaces of the device 400) and the mid-chassis section 428 may be different portions of a single piece of material. In some cases the housing component 410 is formed of a polymer material, reinforced polymer material (e.g., fiber reinforced), carbon fiber, or other suitable material.

The housing components 420, 421, 422, and 423 may each define an exterior corner surface of the device. In some cases, the housing components also define a portion of one or more side exterior surfaces. For example, the housing component 420 defines an exterior corner surface, and a portion of each of two side exterior surfaces (e.g., the side exterior surfaces on the right and top of the housing structure 406, as oriented in FIG. 4B). Similarly, the housing component 421 defines a portion of each of two side exterior surfaces (e.g., the side exterior surfaces on the left and top of the housing structure 406, as oriented in FIG. 4B).

The housing structure 406 may define a first cavity along a first side of the housing structure 406 (e.g., a front-facing side), and a second cavity along a second side of the housing structure 406 (e.g., a rear-facing side) opposite the first side. Components such as the component set 404 (and optionally portions of the rear cover assembly 402) may be positioned in the second cavity, as shown in FIG. 4A, and components such as portions of the front cover assembly 408 may be positioned in the first cavity.

The front cover assembly 408 may include a front cover, such as the front cover 302 in FIG. 3. The front cover assembly 408 may also include a display stack, and touch- and/or force-sensing systems, front-facing sensors such as ambient light sensors, proximity sensors, and the like.

The rear cover assembly 402 may include a rear cover, such as the rear cover 372 in FIG. 3. The rear cover assembly 402 may include wireless charging components, such as a wireless charging coil and magnetic coupling and alignment elements, as well as a flash, a microphone, and optionally other systems. The rear cover assembly 402 may include other components and/or structures as well. For example, the rear cover assembly 402 may also include a mounting structure including mounting tabs or other features, camera covers, optical structures, or the like.

The device 400 may include a component set 404 positioned at least partially in the interior cavity along a side of a mid-chassis section 428 of the housing structure 406. The component set 404 includes components of the device 400. The component set 404 may include a circuit board assembly 452 (e.g., the circuit board assembly 320, FIG. 3), a battery 440 (e.g., the battery 330), a haptic actuator, speakers, antennas and/or other communication components and systems, cameras, microphones, and the like (as described with respect to FIG. 3). Components in the component set 404 may be mechanically and/or conductively coupled to components on the rear cover assembly 402 and the front cover assembly 408. For example, the circuit board assembly 452 may include an electrical connector element 454 that is configured to couple to a corresponding electrical connector element that is coupled to the rear cover assembly 402 (and to the electrical components on the rear cover assembly 402). The electrical connector 454 may be mounted directly on the circuit board assembly 452. The electrical connector element 454 may be a zero insertion force (ZIF) connector, or another suitable connector.

The housing structure 406 provides a mounting and/or support structure for components of the device 400, such as the component set 404, the rear cover assembly 402, and the front cover assembly 408. As described above with respect to FIG. 3, the housing structure 406 may include a middle housing component 410 (e.g., corresponding to the housing component 314) that, together with additional housing components 420, 421, 422, and 423 and joint structures 405 (FIG. 4A), defines peripheral exterior sides/surfaces of the device. The middle housing component 410 also defines a mid-chassis section 428 (e.g., corresponding to the mid-chassis 323). In some cases, the mid-chassis section 428 (also referred to simply as a chassis) is or includes a plate-like structure that extends from one wall section to another wall section (e.g., from the wall section 417 to the wall section 419).

FIG. 4B is an exploded view of the housing structure 406, in which the joint structures are omitted, and the housing components are separated from the middle housing component 410. As shown in FIG. 4B, the middle housing component 410 and the sides may be a single, unitary structure. For example, the middle housing component 410 and the wall sections 417, 419 may be formed by extruding an initial structure (e.g., forming an extruded metal material) that defines the general shape and configuration of the middle housing component 410 and the wall sections 417, 419 (e.g., resembling an “H” shape in cross-section), and then using one or more additional machining or other forming processes to define the final shapes and features of the middle housing component 410 and wall sections 417, 419. The extrusion defining the initial structure of the middle housing component 410 may be formed from a metal material such as aluminum, steel, stainless steel, titanium, or another suitable metal. In some cases, the extrusion may be formed from a polymer material, such as a fiber-reinforced polymer. Machining operations may be applied to the extrusion to form features such as holes, mounting bosses, recesses, protrusions, and the like. Holes that are formed (e.g., via machining or other operations) may accommodate circuit board interconnections, mechanical clips and retention features, buttons, switches, antennas, SIM card trays, and the like.

The housing structure 406 may be formed by structurally joining housing components (e.g., the housing components 420, 421, 422, 423, which may correspond to or be embodiments of housing components 312, 313, 315, and 316) to the middle housing component 410 and to adjacent housing components via joint structures 405 (which may correspond to or be embodiments of joint structures 318). The joint structures 405 may contact, cover, encapsulate, and/or engage with retention features of the housing components and/or the middle housing component 410. As noted above, the wall sections 417, 419 (which may also be referred to as sides or side walls) are part of the single unitary structure of the middle housing component 410, and the joint structures 405 may also function to structurally join the housing components 420, 421, 422, 423 to the middle housing component 410. When coupled via the joint structures 405, the middle housing component 410, the housing components 420, 421, 422, 423, and the joint structures 405 may define a main housing assembly that defines the exterior side surfaces of the device 400.

The mid-chassis section 428 (also referred to simply as a chassis 428) may provide numerous advantages to the device 400. For example, the chassis 428 may act as a mounting structure for device components, such as the battery, circuit board assembly, front and rear cover assemblies, and the like. In this way, fewer components need to be coupled to the front and rear cover assemblies, thereby reducing the complexity of those modules and reducing the number of interconnections (e.g., electrical connections) that need to be made between the various device subassemblies (e.g., between the front cover assembly, rear cover assembly, and other device assemblies).

The chassis 428 also serves a thermal management function for the device 400. The chassis 428 may be formed of or include a thermally conductive material, and heat-producing and/or heat-sensitive components may be thermally coupled to the chassis 428 to help draw heat away from those components or otherwise distribute heat within the device in an advantageous manner. For example, the chassis 428 may be formed from a metal such as aluminum, steel, titanium, metal alloys, or the like. Heat producing and/or heat sensitive components may be thermally coupled to the chassis 428 via thermal couplings, such as graphite films or layers, graphite-wrapped compliant members, thermal paste, or the like. The thermal couplings may have sizes and may be positioned at locations on the chassis 428 that allow the chassis 428 to draw heat away from the heat-producing and/or heat-sensitive components. For example, a circuit board assembly may be thermally (as well as structurally) coupled to the chassis 428 via graphite thermal couplings. Heat from the circuit board assembly (e.g., from a processor of the circuit board assembly) may be transferred to the chassis 428 through the thermal coupling, thereby helping remove heat from the circuit board assembly and reducing the temperature or other thermal impact on the circuit board assembly. The heat may also spread along the chassis 428, resulting in decreased peak temperatures in the device.

Further, the size and location of the thermal couplings on the chassis 428 may be configured to help reduce the amount of heat (e.g., the temperature) reaching user-contacting surfaces or structures of the device 400. For example, by positioning the thermal couplings proximate a center or mid-line of the chassis 428 (e.g., away from the wall sections 417, 419), heat may be directed or concentrated away from the wall sections 417 and 419, which a user may contact when holding the device 400. By contrast, without the thermal couplings, heat from device components, such as from a processor positioned near one of the peripheral sides, may result in a high peak temperature along that side surface, which may make the device uncomfortable to hold. Other device components may be thermally coupled to the chassis 428 as well, including but not limited to a battery, a wireless charging coil, battery charging circuitry, and a display. Device components may be thermally coupled to either side of the chassis 428. In some cases, the chassis 428 is thermally coupled to device components along both sides of the chassis 428 (e.g., along the side facing the front cover assembly and along the opposite side facing the rear cover assembly.

The thermal function of the chassis 428 may improve the operation of the device 400 in several ways. For example, higher processor and battery charge/discharge speeds may be achieved, as they can be operated at higher temperatures without resulting in the device becoming too hot to hold. As another example, the device may remain cooler during operation (e.g., having a lower peak temperature and/or a lower average temperature), rendering the device more comfortable to use and potentially reducing stresses due to thermal cycling.

Device components on one side of the chassis 428 may need access to the other side of the chassis 428. Accordingly, the chassis 428 may include holes extending therethrough to facilitate interconnections and other types of access through the chassis 428. For example, the front cover assembly 408 may include components such as a display stack and forward-facing sensors (e.g., a proximity sensor, ambient light sensor) that connect (e.g., via flexible circuit boards or other conductive couplings) to components in the component set 404. Similarly, the component set 404 may include devices that require access to the front cover assembly 408 (and/or the exterior of the device via the front of the device), such as a forward-facing camera, facial recognition system, and speaker. Accordingly, the chassis 428 may include or define holes, such as holes 412, 414, and 415, to allow access through the chassis 428. For example, components of a front-facing sensor region (e.g., front-facing camera, facial recognition system) that are structurally coupled to the device along one side of the chassis 428 (e.g., the bottom side, which is shown facing up in FIG. 4A) may access the front cover assembly 408 through the hole 414, while electrical connectors 418 and 416 on the front cover assembly 408 (for sensors and a display, respectively) may access components on the other side of the chassis 428 via holes 415 and 412, respectively. In some cases, the number and size of holes in the chassis 428 is minimized in order to maximize the structural and thermal functions of the chassis 428.

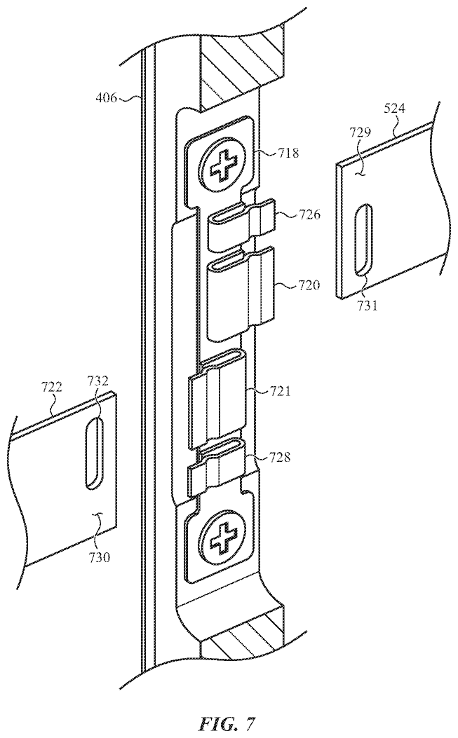

The chassis 428 may also include or define holes 426 (426-1, . . . , 426-3). The holes 426 may facilitate mechanical and/or conductive couplings between the front cover assembly 408 and the housing structure 406, between the rear cover assembly 402 and the housing structure 406, and/or between the front cover assembly 408 and the rear cover assembly 402. For example, the holes 426 may define pass-throughs to allow board-to-board connectors, flexible circuit elements, cables, and the like, to conductively couple components on opposite sides of the chassis 428. As another example, spring coupling elements may be coupled to the housing structure 406 and may be positioned in the holes 426 (such as the spring coupling element 718, FIG. 7), and tabs or other features on the front cover assembly 408 and/or the rear cover assembly 402 (e.g., on a metal frame of the front cover assembly) may be structurally and conductively coupled to the spring coupling elements.

As noted above, the chassis 428 may define an array of mounting bosses 427 (427-1, . . . 427-4) integrally formed with a plate structure of the chassis 428. The mounting bosses 427 may be machined from the same component as the chassis 428 and the wall sections 417, 419 (e.g., an extruded initial structure), such that they are integrally formed with the plate structure of the chassis 428. The mounting bosses may be configured to engage fasteners, such as threaded fasteners (e.g., screws, bolts, etc.) that are used to secure components to the chassis 428. For example, a circuit board assembly (e.g., the circuit board assembly 320, FIG. 3) may be coupled to all or some of the array of mounting bosses 427 via a set of threaded fasteners. While FIGS. 4A-4B illustrate one example arrangement of mounting bosses, this is merely one example arrangement, and more or fewer mounting bosses may be provided in a given implementation. The locations of the mounting bosses may also differ from those shown depending on the positioning of the components that are to be attached to the chassis 428 via the mounting bosses.

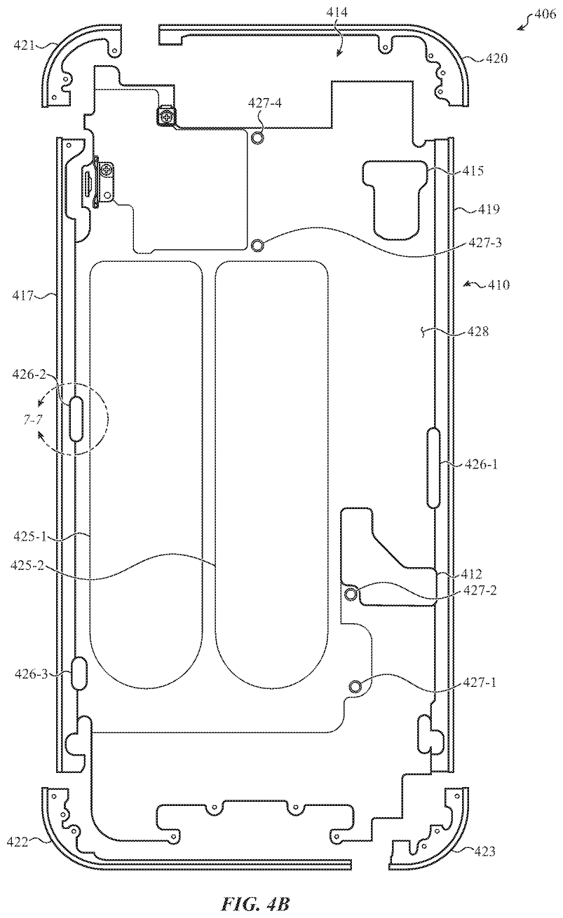

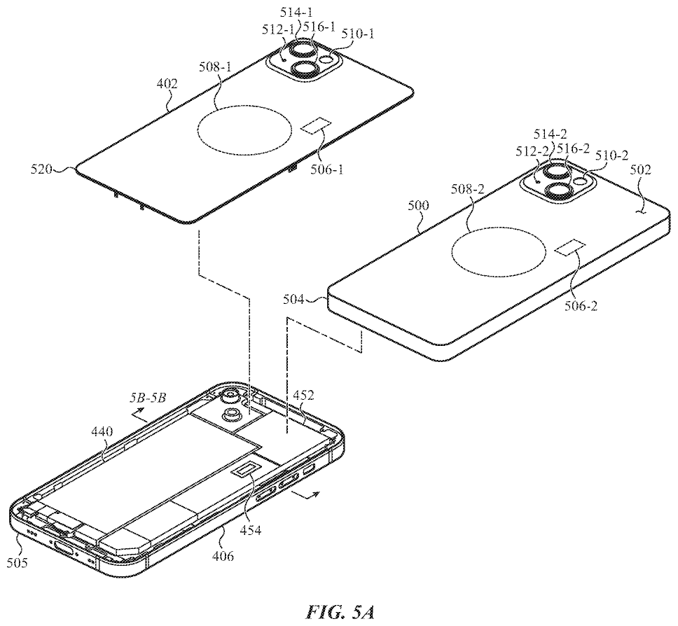

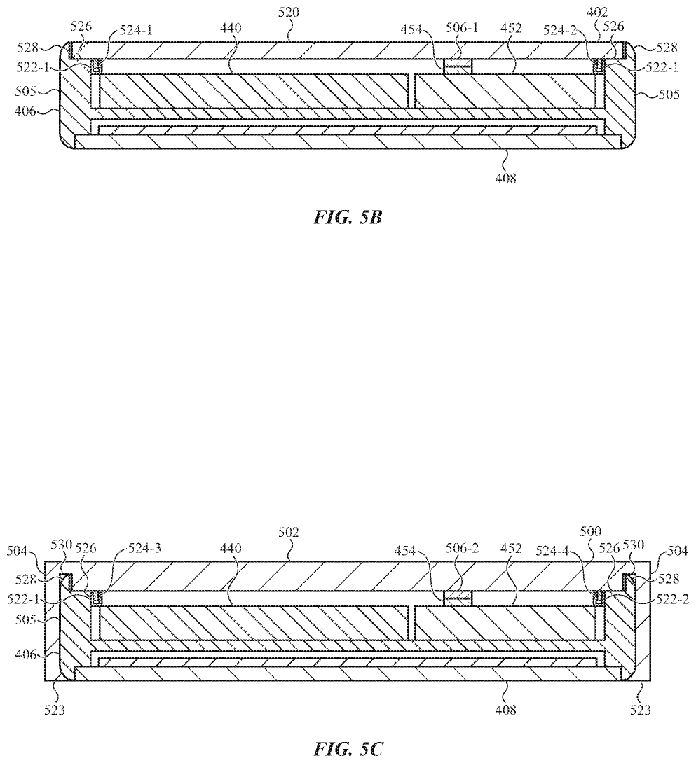

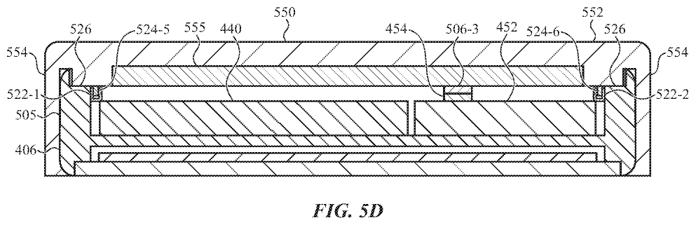

As described above, a device (e.g., a mobile phone) as described herein, may be usable in multiple assembly configurations. FIG. 5A depicts the device 400 (which may correspond to or be an embodiment of the device 100) with a removable rear cover assembly 402, which may be coupled to the housing structure 406 in a first assembly configuration, and a supplemental housing component 400 that may be coupled to the housing structure 406 in a second assembly configuration.

In the first assembly configuration, a removable rear cover assembly 402 is coupled to the housing structure 406. In the first assembly configuration, the peripheral wall of the housing structure 406 defines the side exterior surfaces of the device (e.g., the exposed exterior-facing surfaces of the device), and the removable rear cover assembly 402 defines the rear exterior surface of the device (e.g., the substantial entirety of the rear exterior surface). In the second assembly configuration, a supplemental housing component 500 is coupled to the housing structure 406. The supplemental housing component 500 may be configured to replace the removable rear cover assembly 402 by attaching to the same attachment features in the housing structure 406 as the removable rear cover assembly 402, and by providing some or all of the same components and/or systems provided on the removable rear cover assembly 402 (e.g., wireless charging systems, flashes, microphones, etc.).

The supplemental housing component 500 may include a rear wall 502 and a side wall 504 (e.g., a protective side wall) extending from the rear wall. The rear wall 502 and the side wall 504 may be formed of or include materials that protect the device 100, and optionally, include materials that are stronger and/or tougher than the material of the rear cover 520 of the rear cover assembly 402. For example, the rear wall 502 and the side wall 504 may be formed from or include a polymer material (e.g., silicone, polycarbonate, acrylonitrile butadiene styrene, or the like), and optionally reinforcing members (e.g., metal and/or polymer reinforcing structures), reinforcing fibers (e.g., glass, metal, and/or polymer reinforcing fibers), or the like. The rear wall 502 and/or the side wall 504 may be compliant and/or flexible, such that all or portions of the rear wall 502 and/or the side wall 504 may be deformed, deflected, or otherwise flexed in order to facilitate installation of the supplemental housing component 500 on the device. For example, the side wall 504, or portions thereof, may be bent, flexed, deformed, or otherwise manipulated during installation of the supplemental housing component 500, and may be released when installation is complete (at which time the side wall 504 may return to its original shape and may generally conform to and/or be elastically biased against the peripheral wall 505 of the housing structure). In some cases, the supplemental housing component 500 differs from the rear cover assembly at least in that the supplemental housing component 500 does not include a glass sheet defining its rear wall. By replacing the glass cover of the rear cover assembly with a non-glass rear wall, the supplemental housing component 500 can provide additional strength and/or protection to the device. Moreover, because the rear cover assembly (and thus the glass rear cover 520) is removed entirely (e.g., it does not remain attached to the housing structure 406 when the supplemental housing component 500 is being used), the supplemental housing component 500 provides the protection without adding bulk or having redundant structures on the device (e.g., the device does not include both a rear cover assembly and a protective shell). This also allows the supplemental housing component 500 to have greater access to the internal structures and components of the device, such as direct access to the circuit board assembly 452 and to attachment features within the device.

In the second assembly configuration (when the supplemental housing component 500 is coupled to the housing structure 406 in place of the rear cover assembly 402) the removable rear cover assembly 402 defines the rear exterior surface of the device (e.g., the substantial entirety of the rear exterior surface), and the side wall 504 covers at least a portion of a peripheral wall 505 of the housing structure 406, and optionally completely covers the peripheral wall 505. Additionally, once attached to the housing structure 406 in place of the removable rear cover assembly 402, the side wall 504 of the supplemental housing component 500 defines a side exterior surface of the mobile phone. Stated another way, when the supplemental housing component 500 is coupled to the housing structure 406 in place of the removable rear cover assembly, the side wall 504, rather than the peripheral wall 505 of the housing structure itself, defines the side exterior surface (e.g., the peripheral sides) of the mobile phone.

As noted above, the housing structure 406 may include housing segments that operate as antennas of the device 100. In some cases, the side wall 504 of the supplemental housing component 500 is formed from a dielectric or non-conductive material, such as a polymer (e.g., silicone, polycarbonate, acrylonitrile butadiene styrene (ABS), or another suitable polymer), to allow wireless signals to pass through the side wall 504 to allow the antennas to function while the supplemental housing component 500 is attached.

As described above, the supplemental housing component 500 may include supplemental versions of the same components that are provided on the rear cover assembly 402. For example, the rear cover assembly 402 may include a charging coil 508-1 coupled to the rear cover and configured to wirelessly receive power for charging the device. The rear cover assembly 402 may also include a flash 510-1, a microphone 512-1, and rear-facing camera windows 514-1, 516-1. The rear cover assembly 402 may also include an electrical connector 506-1 that is configured to conductively couple the rear cover assembly 402 (and more particularly, the electrical components of the rear cover assembly 402) to the circuit board assembly 452 inside the housing structure 406. In order to match the functionality of the rear cover assembly 402 while also providing greater protection for the device, the supplemental housing component 500 may include supplemental versions of these components, such as a supplemental charging coil 508-2 coupled to the rear wall of the supplemental housing component, a supplemental flash 510-2, a supplemental microphone 512-2, and supplemental rear-facing camera windows 514-2, 516-2. The rear cover assembly 402 may also include an electrical connector 506-2 that conductively couples to the same corresponding electrical connector 454 on the circuit board assembly 452 that the removable rear cover assembly 402 couples to.

The camera windows 514, 516 of both the rear cover assembly 402 and the supplemental housing component 500 may be recessed relative to the interior surface of the rear cover assembly 402 and the supplemental housing component 500. For example, the rear cover assembly 402 and the supplemental housing component 500 may define holes that extend through the rear wall, and the camera windows 514, 516 may protrude from the rear exterior surface of the rear wall, such that a camera recess is formed along the interior surface of the rear cover assembly. The camera recesses (and the protruding camera windows) may accommodate larger cameras and/or lenses, as the lenses can protrude into the camera recesses, without requiring the overall thickness of the device to be increased. The rear-facing cameras of the device (which remain with the housing structure 406 when the rear cover assembly 402 and the supplemental housing component 500 are removed) may extend into the camera recesses when the rear cover assembly 402 and the supplemental housing component 500 are coupled to the housing structure 406. In some cases, an alignment system helps align the rear-facing cameras with the camera windows 514, 516 (and any corresponding recesses) on the rear cover assembly 402 and the supplemental housing component 500. For example, the rear-facing camera module may define an alignment pin that engages with an alignment hole on the rear-facing sensor array of the rear cover assembly 402 and the supplemental housing component 500.

FIG. 5B is a partial cross-sectional view of the device 400, viewed along line 5B-5B in FIG. 5A, illustrating the device 400 with the removable rear cover assembly 402 attached to the housing structure 406 (e.g., the first assembly configuration). In this assembly configuration, the removable rear cover assembly 402 is attached to the housing structure 406, and is conductively coupled to the circuit board assembly 452 via the corresponding electrical connectors 506-1, 454. As described herein, the electrical connector 506-1 may include a freely movable length of a flexible circuit element (e.g., a flexible strip with integrated conductors) with an electrical connector element such as a ZIF connector coupled thereto. In some cases, the electrical connector 506-1 is mounted to the removable rear cover assembly 402 without a freely movable length of flexible circuit element. In such cases, the electrical connector 506-1 (and/or the mating connector 454) may provide a degree of free movement to allow the electrical connectors to self-align when the removable rear cover assembly is attached to the housing component.

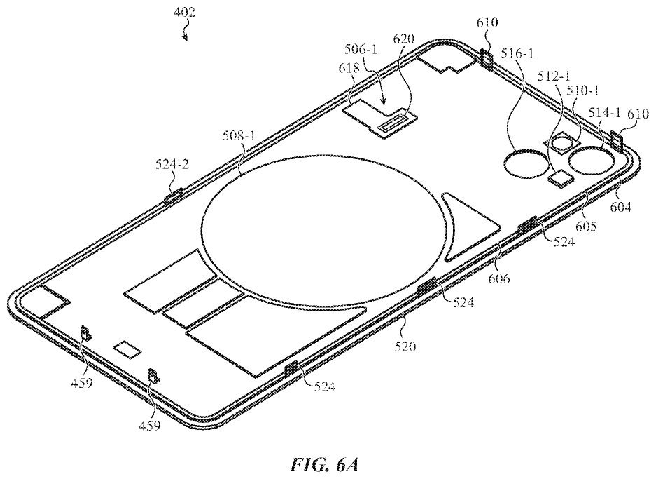

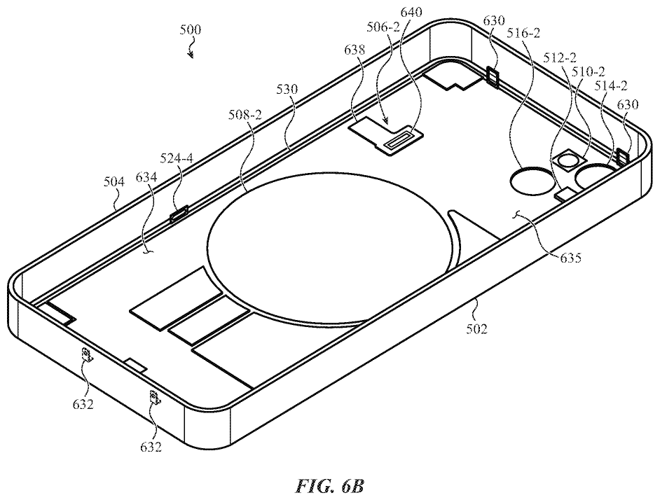

The removable rear cover assembly 402 may be attached to the housing structure 406 via attachment features 522, 524. More particularly, the device 400 may include attachment features 522-1, 522-2 coupled to an interior side of the housing structure 406 (e.g., to the interior side of the peripheral wall 505, opposite the exterior surface of the peripheral wall 505). The attachment features 522 may be spring clips, as described herein with respect to FIG. 7. The removable rear cover assembly 402 may include corresponding attachment features 524-1, 524-2 that engage the attachment features 522-1, 522-2 to retain the removable rear cover assembly 402 to the housing structure 406. The attachment features 524 may be coupled to or extend from a frame member that is coupled to the rear cover 520, as described with respect to FIG. 6A.

In some cases, the removable rear cover assembly 402 may also be attached to the housing structure 406 via an adhesive or other sealing material. For example, an adhesive may be positioned on a ledge 526 defined by the housing structure 406 and on which the removable rear cover assembly 402 sits when fully coupled to the housing structure 406. The adhesive may extend around the entire ledge 526, such that a complete seal and adhesive interface is formed around the peripheral region of the interior-facing surface of the rear cover assembly 402. The adhesive may define an environmental (e.g., waterproof and/or water resistant) seal that prevents or inhibits ingress of water, dirt, dust, and/or other contaminants between the housing structure 406 and the rear cover assembly 402. The adhesive also increases the strength of the coupling between the removable rear cover assembly 402 and the housing structure 406. The adhesive may have a relatively high bonding strength, such that the adhesive alone could securely retain the removable rear cover assembly 402 to the housing structure 406. The adhesive may be at least partially debonded using heat, electrical current, a solvent, or another debonding technique, in order to remove the removable rear cover assembly 402. The removable rear cover assembly 402 may also be attached to the housing structure 406 via fasteners that extend through holes in the housing structure 406 and anchor to fastening features 459 (FIG. 4A).

In the first assembly configuration shown in FIG. 5B, the removable rear cover assembly 402 may be at least partially and optionally fully surrounded about its periphery by a lip or flange portion 528. The outermost part of the flange portion 528 may be flush with (as shown) or proud of the exterior surface of the rear cover 520. Stated another way, the exterior surface of the rear cover 520 may be flush with or recessed relative to the flange portion 528.

FIG. 5C is a partial cross-sectional view of the device 400, viewed along line 5B-5B in FIG. 5A, illustrating the device 400 with the supplemental housing component 500 attached to the housing structure 406 (e.g., the second assembly configuration). In this assembly configuration, the removable rear cover assembly 402 has been removed and/or is omitted entirely, and the supplemental housing component 500 is attached to the housing structure 406 in place of the removable rear cover assembly 402. Because the supplemental housing component 500 also includes components and systems such as a microphone, flash, and charging coil, the supplemental housing component 500 is conductively coupled to the circuit board assembly 452 via the corresponding electrical connectors 506-2, 454. As described herein, the electrical connector 506-2 may include a freely movable length of a flexible circuit element (e.g., a flexible strip with integrated conductors) with an electrical connector element such as a ZIF connector coupled thereto. In some cases, the electrical connector 506-2 is mounted to the supplemental housing component 500 without a freely movable length of flexible circuit element. In such cases, the electrical connector 506-2 (and/or the mating connector 454) may provide a degree of free movement to allow the electrical connectors to self-align when the removable rear cover assembly is attached to the housing component.

The supplemental housing component 500 may be attached to the housing structure 406 via attachment features 522, 524. More particularly, the supplemental housing component 500 may include attachment features 524-3, 524-3 (which may be functionally identical to the attachment features 524-1, 524-2 of the removable rear cover assembly) that engage the attachment features 522-1, 522-2 to retain the supplemental housing component 500 to the housing structure 406. The attachment features 524 may be coupled to or extend from a frame member that is coupled to the rear wall 502 of the supplemental housing component 500, as described with respect to FIG. 6B. Notably, unlike a conventional protective case, the supplemental housing component 500 attaches to the same attachment features within the device that the removable rear cover assembly 402 or attaches to, thereby providing the same structural connection to the housing structure 406 that the rear cover assembly has.

In some cases, the supplemental housing component 500 may also be attached to the housing structure 406 via an adhesive or other sealing material in the same manner as the removable rear cover assembly 402. For example, an adhesive may be positioned on the ledge 526 defined by the housing structure 406 and on which a portion of the supplemental housing component 500 sits when fully coupled to the housing structure 406. The adhesive may extend around the entire ledge 526, such that a complete seal and adhesive interface is formed around the peripheral region of the interior-facing surface of the supplemental housing component 500. The adhesive may define an environmental seal that prevents or inhibits ingress of water, dirt, dust, and/or other contaminants between the housing structure 406 and the supplemental housing component 500. In some cases, an adhesive is also provided between the exterior surface of the peripheral wall 505 of the housing structure 406 and the side wall 504 of the supplemental housing component 500.

The adhesive or adhesives used to couple the supplemental housing component 500 to the housing structure 406 increase the strength of the coupling between the supplemental housing component 500 and the housing structure 406 and may also provide an environment seal between the supplemental housing component 500 and the housing structure 406. The adhesive(s) may have a relatively high bonding strength, such that the adhesive(s) alone could securely retain the supplemental housing component 500 to the housing structure 406. The adhesive may be at least partially debonded using heat, electrical current, a solvent, or another debonding technique, in order to remove the supplemental housing component 500. The supplemental housing component 500 may also be attached to the housing structure 406 via fasteners that extend through holes in the housing structure 406 and anchor to fastening features 632 (FIG. 6B).

Additionally, the rear wall 502 of the supplemental housing component 500 may define a recess 530 that extends around a periphery of the interior side of the rear wall 502. The recess 530 may be configured to accept the flange portion 528 of the housing structure 406 when the supplemental housing component 500 is coupled to the housing structure 406.

FIG. 5C also illustrates the structures that define the exterior surfaces of the device 400 in the second assembly configuration. In particular, in the second assembly configuration, the side wall 504 (which may extend around the entire periphery of the rear wall 502) defines the side exterior surfaces of the device 400 (rather than the peripheral wall 505 of the housing component 406), and the rear wall 502 defines the rear exterior surface of the device 400 (rather than the rear cover of the rear cover assembly 402, which has been removed entirely).

As described herein, a feature of the supplemental housing component 500 is the additional protection that is afforded to the device by the rear wall and side wall construction. In some cases, the supplemental housing component 500 also provides additional protection to the front cover assembly 408 by defining a rim or flange portion 523 that is proud of (e.g., extends past) the front exterior surface of the front cover assembly 408. The flange portion 523 may extend entirely around the periphery of the front cover assembly 408, and may prevent or inhibit objects from contacting the front cover assembly 408 and potentially damaging the front cover assembly 408 or components thereof.

The supplemental housing component 500 may be formed from various materials and/or combinations of materials. In one example, as shown in FIG. 5C, the rear wall 502 and the side wall 504 may be formed from a unitary polymer structure. The polymer of the unitary polymer structure may be silicone, polycarbonate, ABS, or any other suitable polymer, and may include reinforcement members and/or reinforcement fibers, as described above. Other components of the supplemental housing component 500 (e.g., a wireless charging coil, microphone, flash, etc.) may be coupled to the unitary polymer structure, such as via adhesive, fasteners, mechanical interlocks, heat staking, or by molding the polymer material into mechanical engagement with the components.

In some cases, a supplemental housing component may include additional components or systems that are not present in the removable rear cover assembly 402. Indeed, as described herein, a system of supplemental housing components may be provided with different component sets, any of which may be used to replace a removable rear cover assembly 402 to change the overall feature set of the device while also providing protection to the device.

FIG. 5D is a partial cross-sectional view of the device 400, viewed along line 5B-5B in FIG. 5A, illustrating the device 400 with another example supplemental housing component 550 attached to the housing structure 406 (e.g., the second assembly configuration). In this assembly configuration, the removable rear cover assembly 402 has been removed and/or is omitted entirely, and the supplemental housing component 550 is attached to the housing structure 406 in place of the removable rear cover assembly 402. In this example, the supplemental housing component 550 also includes components and systems such as a microphone, flash, and charging coil (e.g., to replace the corresponding components of the removable rear cover assembly 402), and as such the supplemental housing component 550 is conductively coupled to the circuit board assembly 452 via the corresponding electrical connectors 506-3, 454. As described herein, the electrical connector 506-3 may include a flexible circuit element (e.g., a flexible strip with integrated conductors) with an electrical connector element such as a ZIF connector coupled thereto.

The supplemental housing component 550 may be attached to the housing structure 406 via attachment features 522, 524. More particularly, the supplemental housing component 550 may include attachment features 524-5, 524-6 (which may be functionally identical to the attachment features 524-1, 524-2 of the removable rear cover assembly) that engage the attachment features 522-1, 522-2 to retain the supplemental housing component 550 to the housing structure 406. Notably, unlike a conventional protective case, the supplemental housing component 550 attaches to the same attachment features within the device that the removable rear cover assembly 402 attaches to, thereby providing the same structural connection to the housing structure 406 that the rear cover assembly has.

The supplemental housing component 550 may include a rear wall 552 and a side wall 554 extending from the rear wall. The rear wall 552 and the side wall 554 may be formed of or include materials that protect the device 100, and optionally, include materials that are stronger and/or tougher than the material of the rear cover 520 of the rear cover assembly 402. For example, the rear wall 552 and the side wall 554 may be formed from or include a polymer material (e.g., silicone, polycarbonate, acrylonitrile butadiene styrene, or the like), and optionally reinforcing members (e.g., metal and/or polymer reinforcing structures), reinforcing fibers (e.g., glass, metal, and/or polymer reinforcing fibers), or the like. In some cases, the supplemental housing component 550 differs from the rear cover assembly at least in that the supplemental housing component 550 does not include a glass sheet defining its rear wall. By replacing the glass cover of the rear cover assembly with a non-glass rear wall, the supplemental housing component 550 can provide additional strength and/or protection to the device. Moreover, because the rear cover assembly (and thus the glass rear cover 520) is removed entirely (e.g., it does not remain attached to the housing structure 406 when the supplemental housing component 550 is being used), the supplemental housing component 550 provides the protection without adding bulk or having redundant structures on the device (e.g., the device does not include both a rear cover assembly and a protective shell). This also allows the supplemental housing component 550 to have greater access to the internal structures and components of the device, such as direct access to the circuit board assembly 452 and to attachment features within the device.

The supplemental housing component 550 illustrates an example in which a supplemental subsystem 555 is integrated into the supplemental housing component 550 to add to or supplement the functionality of the device 400. In one example, the supplemental subsystem 555 is a supplemental battery that provides power to the device 400. In some cases, the supplemental battery is provided in addition to the battery 440 within the device 400, while in other cases, the battery 440 may be removed from the device and the supplemental battery may be the sole battery for the device 400. In examples where the battery 440 is removed, the supplemental battery may extend into the space within the housing that was previously occupied by the battery 440. The supplemental housing component 550 may also include a charging coil for charging the battery 440 and the supplemental battery.

The supplemental subsystem 555 may be integrated with the structure of the supplemental housing component 550 in various ways. For example, the supplemental subsystem 555 may be attached to a surface of the rear wall 552 via adhesives, fasteners, interlocking features, or the like. As another example, the supplemental subsystem 555 may be at least partially encapsulated by the material of the rear wall 552. For example, the supplemental subsystem 555 may be insert molded with the material of the rear wall 552 (or any other portion of the supplemental housing component 550), such that the material flows around at least a portion of the supplemental subsystem 555 to retain the supplemental subsystem 555 to the supplemental housing component 550. The supplemental subsystem 555 may be conductively coupled to the circuit board assembly 452 via the electrical connectors 506-3, 454. While FIG. 5D depicts the supplemental subsystem 555 as a rectangular component, this is merely for illustration, and the actual shape and configuration of the supplemental subsystem 555 will depend on the configuration of the actual system being included.

As described above, the supplemental subsystem 555 may be a supplemental battery, though this is merely one example of a supplemental subsystem 555 that may be included in a supplemental housing component. In another example, the supplemental subsystem 555 may be a supplemental camera, which may include a lens, an image sensor, and associated electronics to facilitate image capture. In another example, the supplemental subsystem 555 may be one or more speakers configured to produce audio output. The audio output may correspond to media items stored on or otherwise provided to the speakers from the device 400.

In another example, the supplemental subsystem 555 is a rear-facing display. The rear-facing display may be a touch-screen display, or an output-only display. The rear-facing display may have various sizes, resolutions, and other performance parameters. For example, in some cases, the rear-facing display is a high-resolution color display, while in other cases, it is a low-resolution monochrome display. The information to be displayed on the display may be provided by the device 400 via the electrical connectors 506-3, 454.

In another example, the supplemental subsystem 555 may be a physiological sensor and/or a health-monitoring device. In such cases, the supplemental subsystem 555 may include structures and components for interfacing with a user and/or other object for the purposes of determining a physiological parameter or other health-related metric. For example, the supplemental subsystem 555 may include a blood-oxygen sensor. In such cases, the supplemental subsystem 555 may include an optical sensing system (including, for example, a light emitter and a light detector) and associated input surfaces (e.g., a transparent window on which a user may place a finger or other body part) to facilitate blood-oxygen measurements of the user. As another example, the supplemental subsystem 555 may be a blood sugar testing device, and may include a mechanism to receive blood samples (e.g., on paper test strips), and associated analysis components and circuitry to determine a blood glucose level based on the test strip. As yet another example, the supplemental subsystem 555 may include multiple physiological sensors and/or health-monitoring devices. In some cases, the device 400 may be configured to communicate physiological, biometric, and/or health-related data (as detected or otherwise determined by the supplemental subsystem 555) to another device, such as a remote medical device in a clinical setting.

In examples where a supplemental housing component includes a supplemental subsystem that provides additional or different functionality than the removable rear cover assembly, the supplemental housing component may communicate its capabilities to the device 400 via the electrical connectors 506-3, 454, and the device 400 may change one or more operational characteristics based on the communicated capabilities. For example, when a supplemental housing component with a supplemental camera is attached, the device 400 may include the supplemental camera as an image capture option in a camera application. As another example, when a supplemental housing component with supplemental speakers is attached, the device 400 may route audio outputs to the supplemental speakers instead of or in addition to built-in speakers. As yet another example, when a supplemental housing component with a physiological sensor and/or a health-monitoring device is attached, the device 400 may include the physiological sensor and/or a health-monitoring device as a health-data input option in a health-related application. In some cases, when a supplemental housing component with a supplemental subsystem is attached, the device 400 retrieves and/or activates an application that is relevant to that subsystem and which was not available prior to attachment of the supplemental housing component.

FIGS. 6A-6B depict perspective views of an interior side of the removable rear cover assembly 402 and the supplemental housing component 500. The rear cover assembly 402 may include a rear cover 520 and a frame 604 coupled to the rear cover 520. The frame 604 may be formed from metal, and may include mounting and/or retention features that engage with complementary features and/or mechanisms of a housing or housing structure (e.g., the housing structure 406). For example, the rear cover assembly 402 includes tabs 610, attachment features 524, and fastening features 459. The tabs 610 may engage complementary retention features of a housing structure to retain the rear cover assembly 402 to the housing structure. For example, the rear cover assembly 402 may be positioned at an angle to the housing structure to allow protrusions of the housing structure to extend into openings in the tabs 610. The rear cover assembly 402 may then be pivoted towards the housing structure (e.g., while maintaining engagement between the protrusions and the tabs 610) so the rear cover assembly 402 can be secured to the housing structure. When the rear cover assembly 402 is in position relative to the housing structure, the fastening features 459 may align with corresponding fastening features of a front cover assembly, and may be fastened via screws, bolts, or other fasteners that extend through holes in the fastening features 459 (and optionally the fastening features of the front cover assembly as well). The fasteners may extend into and/or be anchored to a hole (e.g., a threaded hole) in a housing structure. In some cases, the fastening features 459 are threaded, and threaded fasteners engage the threads in the fastening features 459.

The frame 604 may include or define a plate-like structure that extends over the interior side of the rear cover 520 (e.g., over substantially all of the rear cover 520, as shown), and defines an interior surface of the rear cover assembly 402. In some cases, a layer 605, such as a graphite film, polymer film, ink, paint, cosmetic layer, or the like, may be positioned on the frame 604.

The rear cover assembly 402 also includes an array of attachment features 524 or tabs (e.g., attachment feature 524-2 shown in FIG. 6A). The attachment features 524 may be part of the frame 604, or they may be attached to the frame 604 (or another component of the rear cover assembly 402). For example, the frame 604 may be formed from or include a metal structure, and the attachment features 524 may be unitary with the frame 604 (e.g., formed of the same metal part as the frame 604). In other cases, the attachment features 524 may be formed separately from the frame 604 and attached to the frame via welding, adhesive, soldering, brazing, fasteners, or another suitable technique. The attachment features 524 may be conductively coupled to the frame 604 or another component of the rear cover assembly 402, and may be used to define a conductive path between the rear cover assembly 402 and a housing structure or other portion of a device, as described with respect to FIG. 7.

FIG. 6A also illustrates an example arrangement of various components of the rear cover assembly 402, including the charging coil 508-1, the flash 510-1, the microphone 512-1, and camera windows 514-1, 516-1. FIG. 6A also illustrates an example electrical connector 506-1, which includes a flexible circuit element 618 and an electrical connector 620 coupled thereto, for conductively coupling the rear cover assembly 402 to a circuit board assembly of a device.

FIG. 6B depicts a perspective view of an interior side of the supplemental housing component 500. The supplemental housing component 500 may include a rear wall 502 and a side wall 504 extending from the rear wall, as described herein. The supplemental housing component 500 may also include a frame 634 coupled to the rear wall 502. The frame 634 may be formed from metal, and may include mounting and/or retention features that engage with complementary features and/or mechanisms of a housing or housing structure (e.g., the housing structure 406). For example, the supplemental housing component 500 includes tabs 630, attachment features 524 (e.g., attachment feature 524-4 shown in FIG. 6B), and fastening features 632. The tabs 630 (which may be identical to or similar to the tabs 610) may engage complementary retention features of a housing structure to retain the supplemental housing component 500 to the housing structure. For example, when assembling the supplemental housing component 500 to the housing structure in place of the removable rear cover assembly, the supplemental housing component 500 may be positioned at an angle to the housing structure to allow protrusions of the housing structure to extend into openings in the tabs 630. The supplemental housing component 500 may then be pivoted towards the housing structure (e.g., while maintaining engagement between the protrusions and the tabs 630) so the supplemental housing component 500 can be secured to the housing structure. When the supplemental housing component 500 is in position relative to the housing structure, the fastening features 632 (which may be identical to or similar to the fastening features 459) may align with corresponding fastening features of a front cover assembly, and may be fastened via screws, bolts, or other fasteners that extend through holes in the fastening features 632 (and optionally the fastening features of the front cover assembly as well). The fasteners may extend into and/or be anchored to a hole (e.g., a threaded hole) in a housing structure. In some cases, the fastening features 632 are threaded, and threaded fasteners engage the threads in the fastening features 632.

The frame 634 may include or define a plate-like structure that extends over the interior side of the rear wall 502 (e.g., over substantially all of the interior side of the rear wall 502, as shown), and defines an interior surface of the supplemental housing component 500. In some cases, a layer 635, such as a graphite film, polymer film, ink, paint, cosmetic layer, or the like, may be positioned on the frame 634.

The supplemental housing component 500 also includes an array of attachment features 524 (e.g., tabs), as described herein. The attachment features 524 (e.g., attachment feature 524-4 shown in FIG. 6B) may be part of the frame 634, or they may be attached to the frame 634 (or another component of the supplemental housing component 500). For example, the frame 634 may be formed from or include a metal structure, and the attachment features 524 may be unitary with the frame 634 (e.g., formed of the same metal part as the frame 634). In other cases, the attachment features 524 may be formed separately from the frame 634 and attached to the frame via welding, adhesive, soldering, brazing, fasteners, or another suitable technique. The attachment features 524 may be conductively coupled to the frame 634 or another component of the supplemental housing component 500, and may be used to define a conductive path between the supplemental housing component 500 and a housing structure or other portion of a device, as described with respect to FIG. 7.

FIG. 6B also illustrates an example arrangement of various components of the supplemental housing component 500, including the charging coil 508-2, the flash 510-2, the microphone 512-2, and camera windows 514-2, 516-2. FIG. 6B also illustrates an example electrical connector 506-2, which includes a flexible circuit element 638 and an electrical connector 640 coupled thereto, for conductively coupling the supplemental housing component 500 to a circuit board assembly of a device.

As described herein, the attachment features 524 of the removable rear cover assembly 402 and the supplemental housing component 500 are both configured to attach to the same set of attachment features that are within the device 400. FIG. 7 illustrates a portion of the device, generally corresponding to region 7-7 in FIG. 4B, showing how the attachment features 524 (e.g., tabs 524) of the removable rear cover assembly 402 and the attachment features 524 of the supplemental housing component 500 (as well as attachment features 722 of a front cover assembly) may be attached to the housing component 406. For ease of illustration, portions of the housing structure 406 are shown in cross-section, as indicated by cross-hatching. As shown in FIG. 7, a spring coupling element 718 may be coupled to a housing structure. For example, the spring coupling element 718 may be coupled to a wall section of the housing structure 406, such as the wall sections 317, 319, or other wall sections (or other housing structures or components) described herein. The spring coupling element 718 may be coupled via fasteners, welding, soldering, brazing, or the like.

The spring coupling element 718 may be conductively coupled to the housing structure 406, and may be configured to both mechanically and electrically couple to the attachment features 524 of the removable rear cover assembly and the supplemental housing component, as well as the attachment features 722 of front cover assembly. The spring coupling element 718 may include spring clips configured to mechanically and electrically couple to the attachment features 524, 722. In some cases, the spring coupling element 718 includes multiple spring clips that engage a single attachment feature. For example, the spring coupling element 718 may include spring clips 720, 726 that engage the attachment feature 524 (of the rear cover assembly and/or supplemental housing component), and spring clips 721, 728 that engage the attachment feature 722 (of the front cover assembly). In some cases, the spring clips may be configured to contact different portions of the attachment features to optimize or otherwise facilitate different functions. For example, the spring clips 720, 721 may be configured to mechanically retain the attachment features 524, 722, while the spring clips 726, 728 may be configured to conductively couple to the attachment features 524, 722 to define a conductive coupling between the front cover assembly, the rear cover assembly (and/or supplemental housing component), and the housing component 406. The spring clips 720, 721 may define protrusions or other features that engage with holes 731, 732 of the attachment features 524, 722 (or lips, recesses, or other features) to provide mechanical retention between the attachment feature and the spring clips.

While the spring clips 720, 721 may also conductively couple to the tabs 524, 722, the interlocking or engaging features of the clips 720, 721 and attachment features 524, 722 may not provide a sufficiently reliable conductive coupling. For example, movement of the attachment feature relative to the spring clips may cause a protrusion and a recess or hole to disengage or otherwise produce a suboptimal conductive connection. Accordingly, the spring clips 726, 728 may engage a different portion of the attachment features 524, 722, such as conductive coupling regions 729, 730 of the attachment features 524, 722, thereby providing a reliable and consistent conductive coupling that can accommodate slight movements and/or misalignments. The conductive coupling regions 729, 730 may be next to the holes 731, 732. The dual clip system thus provides both reliable mechanical coupling and reliable conductive coupling between the cover assemblies and the housing structure with the same attachment feature. Moreover, providing clips for both the front cover assembly and the rear cover assembly on a single structure provides a low-resistance conductive path between the cover assemblies and the housing structure, while reducing overall part count and device complexity.

Both the spring clips 726, 728 and the attachment features 524, 722 may be formed from metal or another conductive material. In some cases, the attachment features and spring clips are part of an electrical ground plane for the device. For example, the attachment features 524, 722 may be conductively coupled to components and/or structures of the rear cover assembly, the supplemental housing component, and the front cover assembly that are part of a designated electrical ground or reference plane. Additionally, the spring clips 726, 728 may be conductively coupled to components and/or structures that are coupled to the housing structure 406 that are part of a designated electrical ground or reference plane. Thus, the spring clips and tabs define a conductive path to define a single electrical ground for the device.

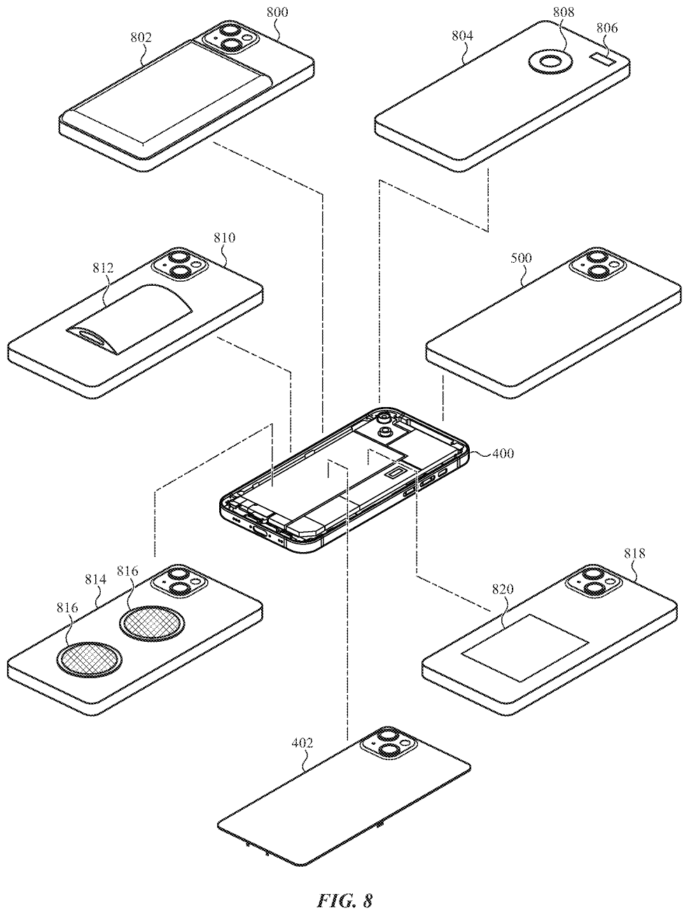

As described herein, the removable rear cover assemblies of a mobile phone facilitate the attachment of various supplemental housing components that provide supplemental and/or enhanced functionality to the phone, while also providing a protective shell along the back and sides of the device, removing redundant components, and providing a high degree of environmental sealing. Thus, a user can select the particular supplemental housing component that provides the desired additional functionality, without compromising the basic functionality, operation, and design of the device. FIG. 8 illustrates a system with an example set of supplemental housing components that may be available to be attached to the device 400, using the same attachment mechanisms as the removable rear cover assembly 402 that may be provided with the device in its standard configuration. In each case, the supplemental housing component conductively couples to the circuit board assembly of the device via the same electrical connector as the removable rear cover assembly, and communications and/or power is sent and received between the supplemental housing component and the circuit board assembly via that same conductive coupling.

One example supplemental housing component is the supplemental housing component 500 as described herein, which may include supplemental versions of the same electrical components and systems of the removable rear cover assembly 402 (e.g., a flash, microphone, and charging coil), while also providing a protective shell along the rear and peripheral sides of the device (and optionally omitting the glass rear cover of the rear cover assembly).

As another example, a supplemental housing component 800 may include a supplemental battery 802, as described with respect to the supplemental housing component 550. The supplemental housing component 800 (via the supplemental battery 802) may provide additional battery capacity to the device 400.

As another example, a supplemental housing component 804 may include a supplemental camera lens 808, supplemental flash 806, as well as associated image sensors and image capture circuitry. The supplemental housing component 804 may exclude the camera windows and the flash that are part of the rear cover assembly, thereby occluding or covering the existing cameras (e.g., for cases in which it is desired for the supplemental camera lens 808 to be the sole camera for the device). In other cases, the supplemental housing component 804 includes the camera windows and flash for the existing device cameras.

As another example, a supplemental housing component 810 may include a physiological sensor and/or a health-monitoring device 812. As shown, the physiological sensor and/or health-monitoring device 812 is a blood glucose testing system that accepts test strips to determine a blood glucose value, though other sensors and/or devices are also contemplated, including but not limited to temperature sensors, photoplethysmographs, blood-oxygen sensors, and electrocardiograph sensors.

As another example, a supplemental housing component 814 may include supplemental speakers 816. When the supplemental housing component 814 is attached to the housing structure 406, device audio (e.g., stored or streaming media, notifications, alerts, etc.) may be routed to the supplemental speakers 816 instead of or in addition to speakers that are coupled to the housing structure 406.

As yet another example, a supplemental housing component 818 may include a rear-facing display 820. The rear-facing display 820 may be a touch-screen display, or an output-only display. The rear-facing display may have various sizes, resolutions, and other performance parameters. For example, in some cases, the rear-facing display is a high-resolution color display, while in other cases, it is a low-resolution monochrome display. The information to be displayed on the rear-facing display 820 may be provided by the device 400 to the supplemental housing component 818.

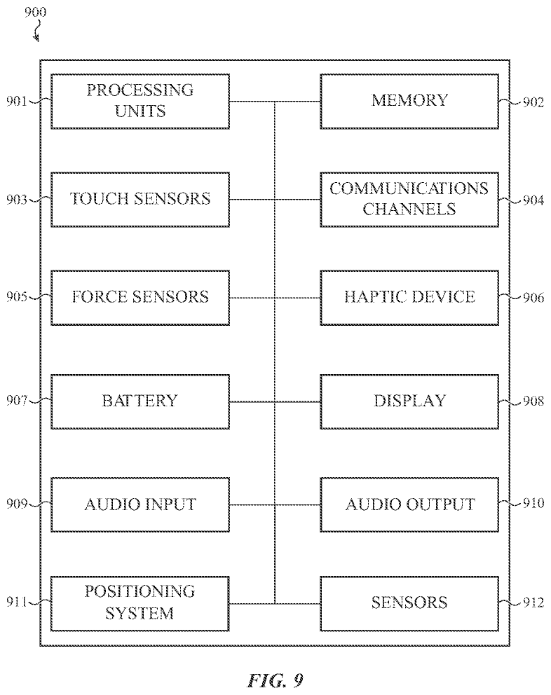

FIG. 9 depicts an example schematic diagram of an electronic device 900. The electronic device 900 may be an embodiment of or otherwise represent the device 100, 300, 400, or other devices described herein. The electronic device 900 may be understood as including either a rear cover assembly such as the removable rear cover assembly 402, or a supplemental housing component (e.g., any of the supplemental housing components described herein). The device 900 includes one or more processing units 901 that are configured to access a memory 902 having instructions stored thereon. The instructions or computer programs may be configured to perform one or more of the operations or functions described with respect to the electronic devices described herein. For example, the instructions may be configured to control or coordinate the operation of one or more displays 908, one or more touch sensors 903, one or more force sensors 905, one or more communication channels 904, one or more audio input systems 909, one or more audio output systems 910, one or more positioning systems 911, one or more sensors 912, one or more haptic feedback devices 906, and any systems or subsystems of a supplemental housing component.

The processing units 901 of FIG. 9 may be implemented as any electronic device capable of processing, receiving, or transmitting data or instructions. For example, the processing units 901 may include one or more of: a microprocessor, a central processing unit (CPU), an application-specific integrated circuit (ASIC), a digital signal processor (DSP), or combinations of such devices. As described herein, the term “processor” is meant to encompass a single processor or processing unit, multiple processors, multiple processing units, or other suitably configured computing element or elements. The processing units 901 may be coupled to a circuit board assembly, such as the circuit board assembly 320.

The memory 902 can store electronic data that can be used by the device 900. For example, a memory can store electrical data or content such as, for example, audio and video files, images, documents and applications, device settings and user preferences, programs, instructions, timing and control signals or data for the various modules, data structures or databases, and so on. The memory 902 can be configured as any type of memory. By way of example only, the memory can be implemented as random access memory, read-only memory, Flash memory, removable memory, or other types of storage elements, or combinations of such devices. The memory 902 may be coupled to a circuit board assembly, such as the circuit board assembly 320.

The touch sensors 903 may detect various types of touch-based inputs and generate signals or data that are able to be accessed using processor instructions. The touch sensors 903 may use any suitable components and may rely on any suitable phenomena to detect physical inputs. For example, the touch sensors 903 may be capacitive touch sensors, resistive touch sensors, acoustic wave sensors, or the like. The touch sensors 903 may include any suitable components for detecting touch-based inputs and generating signals or data that are able to be accessed using processor instructions, including electrodes (e.g., electrode layers), physical components (e.g., substrates, spacing layers, structural supports, compressible elements, etc.), processors, circuitry, firmware, and the like. The touch sensors 903 may be integrated with or otherwise configured to detect touch inputs applied to any portion of the device 900. For example, the touch sensors 903 may be configured to detect touch inputs applied to any portion of the device 900 that includes a display (and may be integrated with a display). The touch sensors 903 may operate in conjunction with the force sensors 905 to generate signals or data in response to touch inputs. A touch sensor or force sensor that is positioned over a display surface or otherwise integrated with a display (e.g., a front-facing display on a front cover assembly, a supplemental rear-facing display on a supplemental housing component) may be referred to herein as a touch-sensitive display, force-sensitive display, or touchscreen.

The force sensors 905 may detect various types of force-based inputs and generate signals or data that are able to be accessed using processor instructions. The force sensors 905 may use any suitable components and may rely on any suitable phenomena to detect physical inputs. For example, the force sensors 905 may be strain-based sensors, piezoelectric-based sensors, piezoresistive-based sensors, capacitive sensors, resistive sensors, or the like. The force sensors 905 may include any suitable components for detecting force-based inputs and generating signals or data that are able to be accessed using processor instructions, including electrodes (e.g., electrode layers), physical components (e.g., substrates, spacing layers, structural supports, compressible elements, etc.), processors, circuitry, firmware, and the like. The force sensors 905 may be used in conjunction with various input mechanisms to detect various types of inputs. For example, the force sensors 905 may be used to detect presses or other force inputs that satisfy a force threshold (which may represent a more forceful input than is typical for a standard “touch” input). Like the touch sensors 903, the force sensors 905 may be integrated with or otherwise configured to detect force inputs applied to any portion of the device 900. For example, the force sensors 905 may be configured to detect force inputs applied to any portion of the device 900 that includes a display (and may be integrated with a display). The force sensors 905 may operate in conjunction with the touch sensors 903 to generate signals or data in response to touch- and/or force-based inputs.

The device 900 may also include one or more haptic devices 906 (e.g., the haptic actuator 322 of FIG. 3). The haptic device 906 may include one or more of a variety of haptic technologies such as, but not necessarily limited to, rotational haptic devices, linear actuators, piezoelectric devices, vibration elements, and so on. In general, the haptic device 906 may be configured to provide punctuated and distinct feedback to a user of the device. More particularly, the haptic device 906 may be adapted to produce a knock or tap sensation and/or a vibration sensation. Such haptic outputs may be provided in response to detection of touch and/or force inputs, and may be imparted to a user through the exterior surface of the device 900 (e.g., via a glass or other surface that acts as a touch- and/or force-sensitive display or surface).

The one or more communication channels 904 may include one or more wireless interface(s) that are adapted to provide communication between the processing unit(s) 901 and an external device. The one or more communication channels 904 may include antennas (e.g., antennas that include or use the housing components of the housings as radiating members), communications circuitry, firmware, software, or any other components or systems that facilitate wireless communications with other devices. In general, the one or more communication channels 904 may be configured to transmit and receive data and/or signals that may be interpreted by instructions executed on the processing units 901. In some cases, the external device is part of an external communication network that is configured to exchange data with wireless devices. Generally, the wireless interface may communicate via, without limitation, radio frequency, optical, acoustic, and/or magnetic signals and may be configured to operate over a wireless interface or protocol. Example wireless interfaces include radio frequency cellular interfaces (e.g., 2G, 3G, 4G, 4G long-term evolution (LTE), 5G, GSM, CDMA, or the like), fiber optic interfaces, acoustic interfaces, Bluetooth interfaces, infrared interfaces, USB interfaces, Wi-Fi interfaces, TCP/IP interfaces, network communications interfaces, or any conventional communication interfaces. The one or more communications channels 904 may also include ultra-wideband (UWB) interfaces, which may include any appropriate communications circuitry, instructions, and number and position of suitable UWB antennas.

As shown in FIG. 9, the device 900 may include a battery 907 that is used to store and provide power to the other components of the device 900. The battery 907 may be a rechargeable power supply that is configured to provide power to the device 900. The battery 907 may be coupled to charging systems (e.g., wired and/or wireless charging systems) and/or other circuitry to control the electrical power provided to the battery 907 and to control the electrical power provided from the battery 907 to the device 900. The battery 907 may correspond to the battery 440 and/or a supplemental battery of a supplemental housing component.

The device 900 may also include one or more displays 908 configured to display graphical outputs. The displays 908 may use any suitable display technology, including liquid crystal displays (LCD), organic light emitting diodes (OLED), active-matrix organic light-emitting diode displays (AMOLED), or the like. The displays 908 may display graphical user interfaces, images, icons, or any other suitable graphical outputs. The display 908 may correspond to a display 103, 303, a rear-facing display of a supplemental housing component, or other displays described herein.

The device 900 may also provide audio input functionality via one or more audio input systems 909. The audio input systems 909 may include microphones, transducers, or other devices that capture sound for voice calls, video calls, audio recordings, video recordings, voice commands, and the like. In some cases, a microphone may be coupled to a supplemental housing component, as described herein.

The device 900 may also provide audio output functionality via one or more audio output systems (e.g., speakers) 910, such as the speaker systems and/or modules 324, 350 and supplemental speakers of a supplemental housing component. The audio output systems 910 may produce sound from voice calls, video calls, streaming or local audio content, streaming or local video content, or the like.

The device 900 may also include a positioning system 911. The positioning system 911 may be configured to determine the location of the device 900. For example, the positioning system 911 may include magnetometers, gyroscopes, accelerometers, optical sensors, cameras, global positioning system (GPS) receivers, inertial positioning systems, or the like. The positioning system 911 may be used to determine spatial parameters of the device 900, such as the location of the device 900 (e.g., geographical coordinates of the device), measurements or estimates of physical movement of the device 900, an orientation of the device 900, or the like.

The device 900 may also include one or more additional sensors 912 to receive inputs (e.g., from a user or another computer, device, system, network, etc.) or to detect any suitable property or parameter of the device, the environment surrounding the device, people, or things interacting with the device (or nearby the device), or the like. For example, a device may include temperature sensors, biometric sensors (e.g., fingerprint sensors, photoplethysmographs, blood-oxygen sensors, blood sugar sensors, or the like), eye-tracking sensors, retinal scanners, humidity sensors, buttons, switches, lid-closure sensors, or the like. Sensors 912 may be part of the component set that is resident on or otherwise coupled to the rear cover assembly, or they may be part of a supplemental housing component.

To the extent that multiple functionalities, operations, and structures described with reference to FIG. 9 are disclosed as being part of, incorporated into, or performed by the device 900, it should be understood that various embodiments may omit any or all such described functionalities, operations, and structures. Thus, different embodiments of the device 900 may have some, none, or all of the various capabilities, apparatuses, physical features, modes, and operating parameters discussed herein. Further, the systems included in the device 900 are not exclusive, and the device 900 may include alternative or additional systems, components, modules, programs, instructions, or the like, that may be necessary or useful to perform the functions described herein.

As described above, one aspect of the present technology is the gathering and use of data available from various sources to improve the usefulness and functionality of devices such as mobile phones. The present disclosure contemplates that in some instances, this gathered data may include personal information data that uniquely identifies or can be used to contact or locate a specific person. Such personal information data can include demographic data, location-based data, telephone numbers, email addresses, twitter IDs, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to locate devices, deliver targeted content that is of greater interest to the user, or the like. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of advertisement delivery services, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data at a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences based on non-personal information data or a bare minimum amount of personal information, such as the content being requested by the device associated with a user, other non-personal information available to the content delivery services, or publicly available information.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art that many modifications and variations are possible in view of the above teachings. Also, when used herein to refer to positions of components, the terms above, below, over, under, left, or right (or other similar relative position terms), do not necessarily refer to an absolute position relative to an external reference, but instead refer to the relative position of components within the figure being referred to. Similarly, horizontal and vertical orientations may be understood as relative to the orientation of the components within the figure being referred to, unless an absolute horizontal or vertical orientation is indicated.

Features, structures, configurations, components, techniques, etc. shown or described with respect to any given figure (or otherwise described in the application) may be used with features, structures, configurations, components, techniques, etc. described with respect to other figures. For example, any given figure of the instant application should not be understood to be limited to only those features, structures, configurations, components, techniques, etc. shown in that particular figure. Similarly, features, structures, configurations, components, techniques, etc. shown only in different figures may be used or implemented together. Further, features, structures, configurations, components, techniques, etc. that are shown or described together may be implemented separately and/or combined with other features, structures, configurations, components, techniques, etc. from other figures or portions of the instant specification. Further, for ease of illustration and explanation, figures of the instant application may depict certain components and/or sub-assemblies in isolation from other components and/or sub-assemblies of an electronic device, though it will be understood that components and sub-assemblies that are illustrated in isolation may in some cases be considered different portions of a single electronic device (e.g., a single embodiment that includes multiple of the illustrated components and/or sub-assemblies).

What is claimed is:

1. A mobile phone comprising:
a housing structure defining a peripheral wall;
a front cover formed of glass and coupled to the housing structure and defining at least a portion of a front exterior surface of the mobile phone;
a display below the front cover;
a circuit board assembly coupled to the housing structure;
a removable rear cover assembly coupled to the housing structure and comprising:
a rear cover formed of glass;
a rear-facing camera window;
a charging coil coupled to the rear cover and configured to wirelessly receive power for charging the mobile phone; and
an electrical connector conductively coupling the removable rear cover assembly to the circuit board assembly; and
a supplemental housing component configured to be coupled to the housing structure in place of the removable rear cover assembly and comprising:
a rear wall formed of a material other than glass and configured to define a rear exterior surface of the mobile phone when the supplemental housing component is coupled to the housing structure in place of the removable rear cover assembly; and
a side wall extending from the rear wall and configured to cover at least a portion of the peripheral wall and define a side exterior surface of the mobile phone when the supplemental housing component is coupled to the housing structure in place of the removable rear cover assembly.

2. The mobile phone of claim 1, wherein:
the housing structure comprises:
a first metal segment defining a first portion of the peripheral wall;
a second metal segment defining a second portion of the peripheral wall; and
a nonconductive joint structure retaining the first metal segment and the second metal segment and defining a third portion of the peripheral wall;
the first metal segment is a first antenna of the mobile phone;
the second metal segment is a second antenna of the mobile phone; and
the side wall of the supplemental housing component covers the first metal segment, the second metal segment, and the nonconductive joint structure.

3. The mobile phone of claim 1, wherein:
the removable rear cover assembly further comprises:
a microphone; and
a flash; and
the electrical connector conductively couples the charging coil, the microphone, and the flash to the circuit board assembly.

4. The mobile phone of claim 3, wherein:
the supplemental housing component comprises:
a supplemental charging coil coupled to the rear wall and configured to wirelessly receive power for charging the mobile phone;
a supplemental microphone;
a supplemental flash; and
a supplemental electrical connector configured to conductively couple the supplemental charging coil, the supplemental microphone, and the supplemental flash to the circuit board assembly when the supplemental housing component is coupled to the housing structure in place of the removable rear cover assembly.

5. The mobile phone of claim 4, wherein:
the mobile phone further comprises a battery;
the supplemental housing component further comprises a supplemental battery; and
the supplemental electrical connector is configured to conductively couple the supplemental battery to the circuit board assembly when the supplemental housing component is coupled to the housing structure in place of the removable rear cover assembly.

6. The mobile phone of claim 1, wherein:
the peripheral wall defines four side exterior surfaces of the housing structure; and
the side wall completely covers at least three of the four side exterior surfaces and extends proud of the front cover.

7. The mobile phone of claim 1, wherein the rear wall and the side wall of the supplemental housing component are formed from a unitary polymer structure.

8. A supplemental housing component for a mobile phone, comprising:
a rear wall configured to replace a removable rear cover assembly of the mobile phone, thereby defining a rear exterior surface of the mobile phone in place of the removable rear cover assembly of the mobile phone;
a protective side wall extending from the rear wall and configured to cover at least a portion of a peripheral wall of a housing of the mobile phone, thereby defining a side exterior surface of the mobile phone;
an attachment feature coupled to the rear wall and configured to attach to a corresponding attachment feature coupled to an interior side of the housing of the mobile phone; and
an electrical connector configured to couple to a corresponding electrical connector within the housing of the mobile phone to electrically couple an electrical system of the supplemental housing component to the mobile phone.

9. The supplemental housing component of claim 8, wherein:
the supplemental housing component further comprises:
a supplemental flash configured to replace a flash coupled to the removable rear cover assembly of the mobile phone;
a supplemental microphone configured to replace a microphone coupled to the removable rear cover assembly of the mobile phone; and
a supplemental charging coil configured to replace a charging coil coupled to the removable rear cover assembly of the mobile phone; and
the electrical connector is configured to couple the supplemental flash, the supplemental microphone, and the supplemental charging coil to the mobile phone.

10. The supplemental housing component of claim 8, wherein the electrical connector is attached to a flexible circuit element that extends from an interior side of the rear wall.

11. The supplemental housing component of claim 8, wherein:
the removable rear cover assembly comprises a rear cover formed of glass; and
the rear wall of the supplemental housing component is formed of a non-glass material.

12. The supplemental housing component of claim 11, wherein the rear wall defines a substantial entirety of a rear surface of the mobile phone.

13. The supplemental housing component of claim 8, wherein the rear wall defines a recess configured to receive a flange portion of a mobile phone housing therein.

14. A mobile phone comprising:
a housing structure operable in:
a first assembly configuration in which a removable rear cover assembly is coupled to the housing structure to define a rear exterior surface of the mobile phone in the first assembly configuration, the housing structure defining a side exterior surface of the mobile phone in the first assembly configuration; and
a second assembly configuration in which a supplemental housing component is coupled to the housing structure to define the rear exterior surface of the mobile phone in the second assembly configuration;
a first attachment feature coupled to the housing structure;
a circuit board assembly at least partially within the housing structure; and
a front cover assembly coupled to the housing structure, wherein:
the removable rear cover assembly comprises:
a rear cover formed of glass;
a second attachment feature coupled to the first attachment feature in the first assembly configuration, thereby releasably coupling the removable rear cover assembly to the housing structure; and
a first electrical connector conductively coupling the removable rear cover assembly to the circuit board assembly in the first assembly configuration; and
the supplemental housing component comprises:
a rear wall configured to define the rear exterior surface of the mobile phone in the second assembly configuration;
a side wall extending from the rear wall and configured to cover at least a portion of a peripheral wall of the mobile phone in the second assembly configuration;
a third attachment feature configured to be coupled to the first attachment feature in the second assembly configuration; and
a second electrical connector configured to conductively couple an electrical system of the supplemental housing component to the circuit board assembly in the second assembly configuration.

15. The mobile phone of claim 14, further comprising:
a first waterproof seal between the removable rear cover assembly and the housing structure in the first assembly configuration; and
a second waterproof seal between the supplemental housing component and the housing structure in the second assembly configuration.

16. The mobile phone of claim 15, wherein the first waterproof seal is a first adhesive and the second waterproof seal is a second adhesive.

17. The mobile phone of claim 14, wherein:
the first attachment feature is a spring clip;
the spring clip is conductively coupled to an electrical ground of the mobile phone;
the second attachment feature is a first metal tab extending from the rear wall of the removable rear cover assembly;
the removable rear cover assembly is conductively coupled to the electrical ground of the mobile phone via the first metal tab and the spring clip;
the third attachment feature is a second metal tab extending from the rear wall of the supplemental housing component; and
the supplemental housing component is conductively coupled to the electrical ground of the mobile phone via the second metal tab and the spring clip.

18. The mobile phone of claim 14, wherein:
the mobile phone further comprises, at least partially within the housing structure:
a battery; and
a rear-facing camera array; and
in the second assembly configuration, an interior surface of the rear wall is positioned directly opposite the circuit board assembly, the battery, and the rear-facing camera array.

19. The mobile phone of claim 14, wherein:
the removable rear cover assembly comprises a camera window configured to cover a rear-facing camera of the mobile phone in the first assembly configuration; and
the supplemental housing component comprises a supplemental camera window configured to cover the rear-facing camera of the mobile phone in the second assembly configuration.

20. A mobile phone comprising:
a housing structure operable in:
a first assembly configuration in which a removable rear cover assembly is coupled to the housing structure to define a rear exterior surface of the mobile phone in the first assembly configuration, the housing structure defining a side exterior surface of the mobile phone in the first assembly configuration; and
a second assembly configuration in which a supplemental housing component is coupled to the housing structure to define the rear exterior surface of the mobile phone and the side exterior surface of the mobile phone in the second assembly configuration;
a front cover formed of glass and coupled to the housing structure and defining at least a portion of a front exterior surface of the mobile phone in the first assembly configuration and the second assembly configuration;
a display below the front cover;
an attachment feature coupled to the housing structure and configured to:
in the first assembly configuration, engage with a first corresponding attachment feature of the removable rear cover assembly to mechanically couple the removable rear cover assembly to the housing structure and conductively couple the removable rear cover assembly to an electrical ground of the mobile phone; and
in the second assembly configuration, engage with a second corresponding attachment feature of the supplemental housing component to mechanically couple the supplemental housing component to the housing structure and conductively couple the supplemental housing component to the electrical ground of the mobile phone;
a rear-facing camera comprising a lens configured to, in the first assembly configuration, extend into a first camera recess of the removable rear cover assembly, and in the second assembly configuration, extend into a second camera recess of the supplemental housing component; and
a circuit board assembly at least partially within the housing structure and comprising an electrical connector configured to:
in the first assembly configuration, engage with a first corresponding electrical connector of the removable rear cover assembly to conductively couple the removable rear cover assembly to a circuit board; and
in the second assembly configuration, engage with a second corresponding electrical connector of the supplemental housing component to conductively couple the supplemental housing component to the circuit board.
